(19) United States
(12) Patent Application Publication
(10) Pub. No.: US 2026/0038888 A1
(43) Pub. Date: Feb. 5, 2026

(54) COLUMNAR SECONDARY BATTERY AND ELECTRONIC DEVICE

(71) Applicant: Xiamen Ampace Technology Limited, Xiamen (CN)

(72) Inventor: Chunhua LI, Xiamen (CN)

(73) Assignee: Xiamen Ampace Technology Limited, Xiamen (CN)

(21) Appl. No.: 19/287,944

(22) Filed: Aug. 1, 2025

(30) Foreign Application Priority Data
Aug. 2, 2024 (CN) 202411059637.8

(51) Int. Cl. H01M 10/42; H01M 4/02; H01M 4/133; H01M 10/0525; H01M 10/0587

(52) U.S. Cl. CPC H01M 10/4235; H01M 4/133; H01M 10/0525; H01M 10/0587; H01M 2004/021; H01M 2004/027

(57) ABSTRACT

A columnar secondary battery includes an electrode assembly. The electrode assembly includes a negative electrode plate. The negative electrode plate includes a negative current collector. A surface of the negative current collector facing away from a winding center of the electrode assembly is coated with a first negative electrode material layer. Along a length direction of the negative electrode plate unwound and along a winding direction of the electrode assembly, the first negative electrode material layer includes a first section and a second section connected sequentially. Based on a length of the first negative electrode material layer, a length of the first section accounts for 9% to 75%, and a length of the second section accounts for 25% to 91%. A plurality of first stripes are provided on the first section, and a plurality of second stripes are provided on the second section.

### CROSS-REFERENCE TO RELATED APPLICATIONS

This application claims the priority of Chinese Application No. 202411059637.8, filed on Aug. 2, 2024, the contents of which is incorporated herein by reference in its entirety.

### TECHNICAL FIELD

This application relates to the field of electrochemical technology, and in particular, to a columnar secondary battery and an electronic device.

### BACKGROUND

Columnar secondary batteries, such as a columnar lithium-ion battery, are applied to a plurality of high-rate discharge systems (in which the discharge rate is greater than 3C, for example), and are widely used in the field of consumer electronics by virtue of a high specific energy, a high working voltage, a low self-discharge rate, a small size, a light weight, and other characteristics.

Currently, the design of high-power columnar lithium-ion batteries is typically a full-tab design, in which a positive tab and a negative tab extend from opposite directions and are prepared using a full-tab smooth-out or flattening technology. However, in a later stage of cycling of a full-tab columnar lithium-ion battery, insufficient infiltration for electrode plates and loss of a cell balance (CB) value deteriorate the kinetic performance of the lithium-ion battery and accelerate the lithium plating and cycle fading of the lithium-ion battery.

### SUMMARY

An objective of this application is to provide a columnar secondary battery and an electronic device to improve infiltration performance of an electrolyte solution for a negative electrode plate while reducing a CB loss, thereby improving the lithium plating suppression performance and cycle performance of the columnar secondary battery.

It is hereby noted that in the subject matter hereof, this application is construed by using a lithium-ion battery as an example of the columnar secondary battery, but the columnar secondary battery of this application is not limited to the lithium-ion battery. Specific technical solutions are as follows:

A first aspect of this application provides a columnar secondary battery. The columnar secondary battery includes an electrode assembly. The electrode assembly includes a positive electrode plate, a negative electrode plate, and a separator. The negative electrode plate includes a negative current collector. A surface of the negative current collector facing away from a winding center of the electrode assembly is coated with a first negative electrode material layer. Along a length direction of the negative electrode plate unwound and along a winding direction of the electrode assembly, the first negative electrode material layer includes a first section and a second section connected sequentially. Based on a length of the first negative electrode material layer, a length of the first section accounts for 9% to 75%, and a length of the second section accounts for 25% to 91%. Optionally, based on the length of the first negative electrode material layer, the length of the first section accounts for 17% to 60%, and the length of the second section accounts for 40% to 83%. A plurality of first stripes are provided on the first section. The plurality of first stripes extend along a width direction of the negative electrode plate unwound and are spaced apart along a length direction of the negative electrode plate unwound. A plurality of second stripes are provided on the second section. The plurality of second stripes extend along the width direction of the negative electrode plate unwound and are spaced apart along the length direction of the negative electrode plate unwound. Along a thickness direction of the negative electrode plate, an average depth of the plurality of first stripes in the first section is H₁ μm, an average depth of the plurality of second stripes in the second section is H₂ μm, and a thickness of the first negative electrode material layer is H₀ μm, satisfying: 50≤H₀≤100, 0.15≤H₂/H₀≤0.7, and 0.45≤H₁/H₂≤0.95. Optionally, 0.3≤H₂/H₀≤0.6, and 0.7≤H₁/H₂≤0.85. By optimizing the settings of the stripes on the negative electrode plate and providing the first stripes and second stripes of different depths, this application effectively reduces the risks of lithium plating and cycle performance fading caused by insufficiency of the CB value due to stripes provided at an inner turn (a winding start section) of the negative electrode plate at which a CB value is relatively low. The settings also enable a good infiltration effect of an electrolyte solution for the negative electrode plate, so that the columnar secondary battery exhibits a low degree of lithium plating and high cycle performance.

In one or more embodiments, along the length direction of the negative electrode plate unwound, a spacing between two adjacent first stripes is A₁ mm, and a spacing between two adjacent second stripes is A₂ mm, satisfying: 0.2≤A₁/A₂≤3, and 2≤A₂≤10. Optionally, 0.5≤A₁/A₂≤1.5. By controlling the values of A₁/A₂ and A₂ to fall within the above ranges, this application improves the efficiency and performance of the electrolyte solution for infiltrating the negative electrode plate, thereby improving the lithium plating suppression performance and cycle performance of the columnar secondary battery.

In one or more embodiments, along the length direction of the negative electrode plate unwound, a width of a single first stripe is W₁ μm, and a width of a single second stripe is W₂ μm, satisfying: 0.1≤W₁/W₂≤1.5, and 70≤W₂≤120. Optionally, 0.6≤W₁/W₂≤1.2. By controlling the values of W₁/W₂ and W₂ to fall within the above ranges, this application reduces the risk of insufficient infiltration of the electrolyte solution for the negative electrode plate, and improves the lithium plating suppression performance and cycle performance of the columnar secondary battery while achieving a desirable energy density.

In one or more embodiments, along the width direction of the negative electrode plate unwound, a ratio of a length of a single first stripe to a width of the first negative electrode material layer is P₁, satisfying: 0.2≤P₁≤1; or, a ratio of a length of a single second stripe to a width of the first negative electrode material layer is P₂, satisfying: 0.2≤P₂≤1. Optionally, 0.3≤P₁≤0.8; and 0.3≤P₂≤0.8. By controlling the values of P₁ and P₂ to fall within the above ranges, this application facilitates circulation of the electrolyte solution on the first negative electrode material layer, thereby improving the lithium plating suppression performance and cycle performance of the columnar secondary battery.

In one or more embodiments, along the width direction of the negative electrode plate unwound, the negative current collector includes a blank foil region connected to the first negative electrode material layer. The blank foil region is provided with a plurality of third stripes. The plurality of third stripes extend along the width direction of the negative electrode plate unwound and are spaced apart along the length direction of the negative electrode plate unwound. By providing the third stripes in the blank foil region, this application provides more electrolyte guide channels for the blank foil region, especially for the flattened part in the blank foil region, thereby improving the consistency of internal resistance on the secondary battery level, and improving the cycle performance and lithium plating suppression performance of the columnar secondary battery.

In one or more embodiments, along the width direction of the negative electrode plate unwound, a ratio of a length of a single third stripe to a width of the blank foil region is P₃, satisfying: 0.1≤P₃≤0.7. Optionally, 0.2≤P₃≤0.5. By controlling the value of P₃ to fall within the above range, this application facilitates circulation of the electrolyte solution in the blank foil region, thereby improving the lithium plating suppression performance and cycle performance of the columnar secondary battery while achieving desirable mechanical safety performance.

In one or more embodiments, along the thickness direction of the negative electrode plate, a thickness of the negative current collector is T₀ μm, an average depth of a plurality of third stripes in a part of the blank foil region opposite to the first section is T₁ μm, and an average depth of a plurality of third stripes in a part of the blank foil region opposite to the second section is T₂ μm, satisfying: 3≤T₀≤20, 0.15≤T₂/T₀≤0.7, and 0.45≤T₁/T₂≤0.95. By controlling the values of T₁/T₀, T₂/T₀, and T₀ to fall within the above ranges, this application makes it convenient to provide the third strips of different depths in the blank foil region, thereby improving the cycle performance of the columnar secondary battery while achieving desirable mechanical safety performance.

A second aspect of this application provides an electronic device. The electronic device includes the columnar secondary battery disclosed in any one of the preceding embodiments. The columnar secondary battery of this application exhibits good cycle performance and lithium plating suppression performance. Therefore, the electronic device of this application achieves a long service life.

Beneficial effects of some embodiments of this application are as follows:

By optimizing the settings of the stripes on the negative electrode plate and providing the first stripes and second stripes of different depths, some embodiments of this application effectively reduce the risks of lithium plating and cycle performance fading caused by insufficiency of the CB value due to stripes provided at an inner turn of the negative electrode plate at which a CB value is relatively low. The settings also enable a good infiltration effect of an electrolyte solution for the negative electrode plate, so that the columnar secondary battery exhibits a low degree of lithium plating and high cycle performance.

Definitely, a single product or method in which the technical solution of this application is implemented does not necessarily achieve all of the above advantages concurrently.

### BRIEF DESCRIPTION OF DRAWINGS

To describe the technical solutions in some embodiments of this application or the prior art more clearly, the following outlines the drawings to be used in the description of some embodiments of this application or the prior art. Evidently, the drawings outlined below merely illustrate some embodiments of this application, and a person of ordinary skill in the art may derive other embodiments from the drawings.

FIG. 1 is a schematic diagram of a jelly-roll structure of an electrode assembly according to an embodiment of this application;

FIG. 2 is a partial front view of a negative electrode plate of the electrode assembly shown in FIG. 1 after the electrode assembly is unwound;

FIG. 3 is a cross-sectional view of the negative electrode plate shown in FIG. 2 sectioned along a P-P direction;

FIG. 4 is a cross-sectional view of a negative electrode plate sectioned along a P-P direction according to another embodiment of this application;

FIG. 5 is a partial front view of a negative electrode plate according to still another embodiment of this application;

FIG. 6 is a partial front view of a negative electrode plate according to still another embodiment of this application;

FIG. 7 is a partial front view of a negative electrode plate according to still another embodiment of this application; and

FIG. 8 is a cross-sectional view of the negative electrode plate shown in FIG. 7 sectioned along a Q-Q direction.

List of reference signs: electrode assembly 001; positive electrode plate 10; positive current collector 11; positive electrode material layer 12; negative electrode plate 20; negative current collector 21; first negative electrode material layer 22; second negative electrode material layer 23; separator 30; first stripe 221; second stripe 222; blank foil region 210; third stripe 211; fourth stripe 231.

### DETAILED DESCRIPTION

The following describes the technical solutions in some embodiments of this application clearly in detail with reference to the drawings appended hereto. Evidently, the described embodiments are merely a part of but not all of the embodiments of this application. All other embodiments derived by a person skilled in the art based on this application still fall within the protection scope of this application.

It is hereby noted that in specific embodiments of this application, this application is construed by using a lithium-ion battery as an example of the columnar secondary battery, but the columnar secondary battery of this application is not limited to the lithium-ion battery.

For a high-power columnar secondary battery, which is typically a full-tab columnar lithium-ion battery, in the later stage of cycling, the infiltration effect of an electrolyte solution is inferior on a surface of a negative electrode plate facing away from a winding center of an electrode assembly, especially at a position close to the winding center of the electrode assembly, and the negative electrode plate is not well infiltrated, thereby deteriorating the cycle performance of the lithium-ion battery. In the prior art, the infiltration for the electrode plate is improved by grooving. However, an initial CB value on a surface of the negative electrode plate at an inner turn facing away from the center of the electrode assembly is lower than that at other positions. Therefore, when the overall capacity of the negative electrode plate fades in the later stage of cycling, the CB value here becomes insufficient and lithium plating occurs, thereby affecting the kinetic performance and cycle performance of the columnar lithium-ion battery. Therefore, this application provides a columnar secondary battery. The negative electrode plate of the columnar secondary battery is well infiltrated, and the secondary battery exhibits good lithium plating suppression performance and cycle performance. Specific technical solutions are as follows:

A first aspect of this application provides a columnar secondary battery. The columnar secondary battery includes an electrode assembly. The electrode assembly includes a positive electrode plate, a negative electrode plate, and a separator. The negative electrode plate includes a negative current collector. A surface of the negative current collector facing away from a winding center of the electrode assembly is coated with a first negative electrode material layer. Along a length direction of the negative electrode plate unwound and along a winding direction of the electrode assembly, the first negative electrode material layer includes a first section and a second section connected sequentially. Based on the length of the first negative electrode material layer, the length of the first section accounts for a proportion K₁ of 9% to 75%, and the length of the second section accounts for a proportion K₂ of 25% to 91%. Optionally, based on the length of the first negative electrode material layer, the length of the first section accounts for a proportion K₁ of 17% to 60%, and the length of the second section accounts for a proportion K₂ of 40% to 83%. For example, the length of the first section may account for a proportion K₁ of 9%, 10%, 12%, 15%, 17%, 20%, 22%, 25%, 28%, 30%, 32%, 35%, 38%, 40%, 42%, 45%, 48%, 50%, 52%, 55%, 58%, 60%, 62%, 65%, 68%, 70%, 72%, 75%, or a value falling within a range formed by any two thereof; and the length of the second section may account for a proportion K₂ of 25%, 28%, 30%, 32%, 35%, 38%, 40%, 42%, 45%, 48%, 50%, 52%, 55%, 58%, 60%, 62%, 65%, 68%, 70%, 72%, 75%, 78%, 80%, 83%, 85%, 88%, 90%, 91%, or a value falling within a range formed by any two thereof. A plurality of first stripes are provided on the first section. The plurality of first stripes extend along a width direction of the negative electrode plate unwound and are spaced apart along a length direction of the negative electrode plate unwound. A plurality of second stripes are provided on the second section. The plurality of second stripes extend along the width direction of the negative electrode plate unwound and are spaced apart along the length direction of the negative electrode plate unwound. Along a thickness direction of the negative electrode plate, an average depth of the plurality of first stripes in the first section is H₁ μm, an average depth of the plurality of second stripes in the second section is H₂ μm, and a thickness of the first negative electrode material layer is H₀ μm, satisfying: 50≤H₀≤100, 0.15≤H₂/H₀≤0.7, and 0.45≤ H₁/H₂≤0.95. Optionally, 0.3≤H₂/H₀≤0.6, and 0.7≤H₁/H₂≤0.85. For example, the value of H₀ may be 50, 52, 55, 58, 60, 62, 65, 68, 70, 72, 75, 78, 80, 82, 85, 88, 90, 92, 95, 98, 100, or a value falling within a range formed by any two thereof; the value of H₂/H₀ may be 0.15, 0.18, 0.2, 0.22, 0.25, 0.28, 0.3, 0.32, 0.35, 0.38, 0.4, 0.42, 0.45, 0.48, 0.5, 0.52, 0.55, 0.58, 0.6, 0.62, 0.65, 0.68, 0.7, or a value falling within a range formed by any two thereof; and the value of H₁/H₂ may be 0.45, 0.48, 0.5, 0.52, 0.55, 0.58, 0.6, 0.62, 0.65, 0.68, 0.7, 0.72, 0.75, 0.78, 0.8, 0.82, 0.85, 0.88, 0.9, 0.92, 0.95, or a value falling within a range formed by any two thereof.

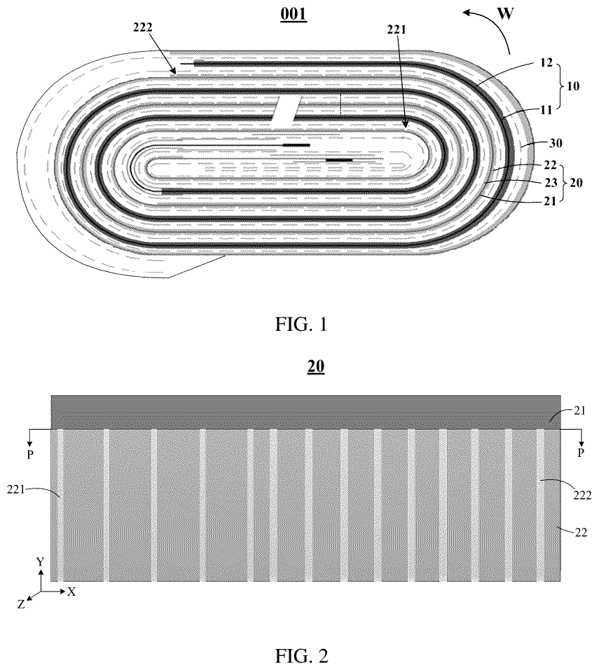

In this application, it is defined that in an unwound state of the electrode assembly, the length direction of the electrode assembly is an X direction, the width direction of the electrode assembly is a Y direction, and the thickness direction of the electrode assembly is a Z direction. Understandably, in an unwound state, the length direction, width direction, and thickness direction of the negative electrode plate, the positive electrode plate, and the separator are the same as the length direction, width direction, and thickness direction of the electrode assembly, respectively, and the winding direction of the electrode assembly is a W direction. As shown in FIG. 1 to FIG. 3, the electrode assembly 001 includes a positive electrode plate 10, a negative electrode plate 20, and a separator 30. The negative electrode plate 20 includes a negative current collector 21. A surface of the negative current collector 21 facing away from a winding center of the electrode assembly 001 is coated with a first negative electrode material layer 22. Along the length direction (X direction) of the negative electrode plate 20 unwound and along the winding direction (W direction) of the electrode assembly 001, the first negative electrode material layer 22 includes a first section (not shown in the figure) and a second section (not shown in the figure) connected sequentially. A plurality of first stripes 221 are provided on the first section. The plurality of first stripes 221 extend along the width direction (Y direction) of the negative electrode plate 20 unwound and are spaced apart along the length direction (X direction) of the negative electrode plate 20 unwound. A plurality of second stripes 222 are provided on the second section. The plurality of second stripes 222 extend along the width direction of the negative electrode plate 20 unwound and are spaced apart along the length direction (X direction) of the negative electrode plate 20 unwound. An average depth of the plurality of first stripes 221 in the first section is H₁ μm, an average depth of the plurality of second stripes 222 in the second section is H₂ μm, an average depth of the plurality of first stripes 221 in the third section is H₃ μm, and the thickness of the first negative electrode material layer 22 is H₀ μm.

When the length of the first section accounts for an excessively low proportion K₁, for example, a proportion less than a lower limit specified herein, that is, when the length of the second section accounts for an excessively high proportion K₂, the region provided with the second stripes on the first negative electrode material layer is excessively large. Consequently, the electrolyte solution on the negative electrode plate is excessive in amount, and is prone to react parasitically with a negative active material, thereby increasing an anode-electrolyte interface impedance, and making the anode-electrolyte interface prone to lithium plating. At the same time, the loss of the negative active material is excessive, thereby not only reducing the energy density of the secondary battery, but also further increasing the risk of lithium plating on the anode-electrolyte interface due to insufficiency of a CB value on the surface of the negative electrode plate, especially at position on the negative electrode plate near the winding center of the electrode assembly (at the inner turn or the winding start section of the negative electrode plate), and in turn, affecting the lithium plating suppression performance and cycle performance of the secondary battery. When the length of the first section accounts for an excessively high proportion K₁, for example, a proportion greater than an upper limit specified herein, that is, when the length of the second section accounts for an excessively low proportion K₂, the region provided with the second stripes on the first negative electrode material layer is excessively small, thereby being adverse to circulation of the electrolyte solution on the negative electrode plate. The infiltration effect of the electrolyte solution for the negative electrode plate is inferior, the kinetics of the negative electrode plate are deteriorated and prone to cause lithium plating, and the cycle performance and lithium plating suppression performance of the secondary battery are not significantly improved. When the value of H₂/H₀ is excessively small, for example, less than a lower limit specified herein, the depth of the second stripes on the first negative electrode material layer is excessively small, thereby being adverse to circulation of the electrolyte solution on the negative electrode plate. The infiltration effect of the electrolyte solution for the negative electrode plate is inferior, and the electrochemical impedance of the negative electrode plate is relatively large. The kinetics of the negative electrode plate are deteriorated and prone to cause lithium plating, and the cycle performance and lithium plating suppression performance of the secondary battery are not significantly improved. When the value of H₂/H₀ is excessively large, for example, greater than an upper limit specified herein, the depth of the second stripes on the first negative electrode material layer is excessively large. The loss of the negative active material is excessive, thereby further increasing the risk of lithium plating on the anode-electrolyte interface due to insufficiency of the CB value, and in turn, affecting the lithium plating suppression performance and cycle performance of the secondary battery. When the value of H₁/H₂ is excessively small, that is, less than a lower limit specified herein, the circulation of the electrolyte solution on the negative electrode plate is not facilitated. The anode-electrolyte interface impedance is prone to increase due to insufficient infiltration of the electrolyte solution in the later stage of cycling, thereby affecting the cycle performance of the secondary battery. When the value of H₁/H₂ is excessively large, that is, greater than an upper limit specified herein, the loss of the negative active material is excessive on the negative electrode plate at a position near the winding center of the electrode assembly, that is, at the inner turn of the negative electrode plate, thereby further increasing the risk of lithium plating at the anode-electrolyte interface due to insufficiency of the CB value, reducing the safety performance of the secondary battery, and in turn, affecting the lithium plating suppression performance and cycle performance of the secondary battery. In this application, the first stripes are provided on the first section, and the second stripes are provided on the second section. The values of the length proportion K₁ of the first section, the length proportion K₂ of the second section, H₀, H₂/H₀, and H₁/H₂ are controlled to fall within the above ranges. The first stripes and the second stripes are arranged in coordination to achieve a synergistic effect between the first stripes and the second stripes, thereby accelerating circulation of the electrolyte solution on the negative electrode plate, and effectively improving the efficiency and performance of infiltration by the electrolyte solution on the negative electrode plate level. This arrangement not only ensures a desirable infiltration effect of the electrolyte solution for the negative electrode plate, but also reduces the risk of lithium plating and cycle performance fading of the negative electrode plate, especially at the inner turn of the negative electrode plate at which the CB value is relatively low (at a position near the winding center of the electrode assembly, or at the winding start section of the negative electrode plate) due to insufficiency of the CB value, thereby improving the lithium plating suppression performance and cycle performance of the secondary battery. The above arrangement not only ensures a good infiltration effect of the electrolyte solution for the negative electrode plate, but also endows the columnar secondary battery with good lithium plating suppression performance and cycle performance. In this application, the “surface” in “a surface of the negative current collector facing away from the winding center of the electrode assembly” may be the entire surface region of the negative current collector, or a partial surface region of the negative current collector, without being particularly limited herein, as long as the objectives of the application can be achieved. In this application, the thickness H₀ of the first negative electrode material layer may be controlled by means known to a person skilled in the art. For example, when a negative electrode slurry is applied onto the surface of the negative current collector, to the extent that the solid content of the negative electrode slurry is constant, the thickness H₀ of the first negative electrode material layer can be increased by increasing the coating weight; and the thickness H₀ of the first negative electrode material layer can be reduced by reducing the coating weight. Further, during cold-pressing of the negative electrode plate, the thickness H₀ of the first negative electrode material layer can be reduced by increasing the cold-pressing pressure, and the thickness H₀ of the first negative electrode material layer can be increased by reducing the cold-pressing pressure.

In this application, the CB value means a ratio of a capacity of the negative electrode plate per unit area to a capacity of the positive electrode plate per unit area under the same conditions, for example, at an ambient temperature of 25° C. and a discharge rate of 0.1C. CB=(gravimetric capacity of the negative active material×mass of the negative active material per unit area of the negative electrode plate)/(gravimetric capacity of the positive active material×mass of the positive active material per unit area of the positive electrode plate), where “unit area” means 1 mm².

In one or more embodiments, 7.5≤H₂≤70; and/or 3.375≤H₁≤66.5. For example, the value of H₂ may be 7.5, 7.8, 8, 10, 12, 15, 18, 20, 22, 25, 28, 30, 32, 35, 38, 40, 42, 45, 48, 50, 52, 55, 58, 60, 62, 65, 68, 70, or a value falling within a range formed by any two thereof; and the value of H₁ may be 3.375, 3.4, 3.5, 3.8, 4, 5, 8, 10, 12, 15, 18, 20, 22, 25, 28, 30, 32, 35, 38, 40, 42, 45, 48, 50, 52, 55, 58, 60, 62, 65, 66, 66.5, or a value falling within a range formed by any two thereof. The values of H₂ and H₁ are controlled to fall within the above ranges, and the first stripes and the second stripes are arranged in coordination to achieve a synergistic effect between the first stripes and the second stripes, thereby accelerating circulation of the electrolyte solution on the negative electrode plate, and effectively improving the efficiency and performance of infiltration by the electrolyte solution on the negative electrode plate level. This arrangement not only ensures a desirable infiltration effect of the electrolyte solution for the negative electrode plate, but also reduces the risk of lithium plating and cycle performance fading of the negative electrode plate, especially at the inner turn of the negative electrode plate at which the CB value is relatively low (at a position near the winding center of the electrode assembly, or at the winding start section of the negative electrode plate) due to insufficiency of the CB value, thereby improving the lithium plating suppression performance and cycle performance of the secondary battery.

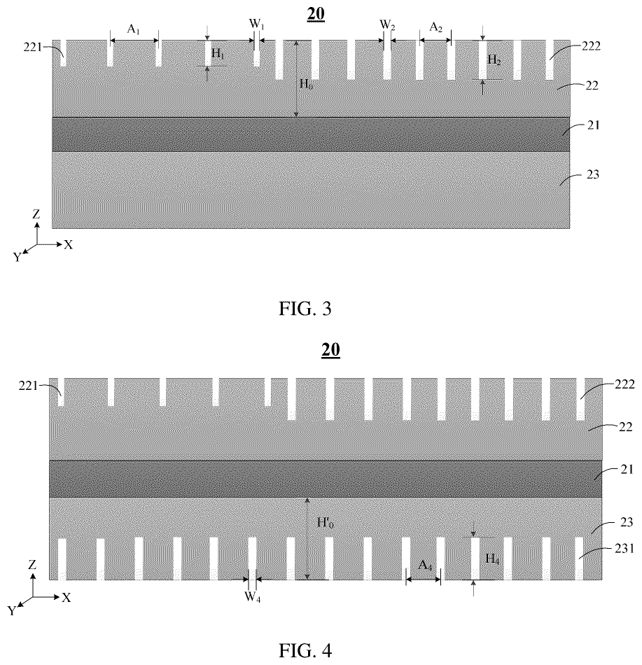

In one or more embodiments, as shown in FIG. 3, along the length direction (X direction) of the negative electrode plate 20 unwound, a spacing between two adjacent first stripes 221 is A₁ mm, and a spacing between two adjacent second stripes 222 is A₂ mm, satisfying: 0.2≤A₁/A_{2≤3}, and 2≤A₂≤10. Optionally, 0.5≤A₁/A_{2≤1.5}. For example, the value of A₁/A₂ may be 0.2, 0.5, 0.8, 1, 1.2, 1.5, 1.8, 2, 2.2, 2.5, 2.8, 3, or a value falling within a range formed by any two thereof; and the value of A₂ may be 2, 3, 4, 5, 6, 7, 8, 9, 10, or a value falling within a range formed by any two thereof. By controlling the values of A₁/A₂ and A₂ to fall within the above ranges, the circulation of the electrolyte solution on the negative electrode plate is facilitated, and the electrolyte solution can easily flow to the inner turn of the negative electrode plate, thereby improving the infiltration effect of the electrolyte solution for the negative electrode plate, improving the infiltration performance of the electrolyte solution for the negative electrode plate, also reducing the processing difficulty of the grooving process and the risk of local collapse of the first negative electrode material layer, and in turn, improving the lithium plating suppression performance and cycle performance of the columnar secondary battery. In this application, the spacing between two adjacent first stripes means a distance between width centers of the two adjacent first stripes along the length direction of the negative electrode plate unwound. The spacing between two adjacent second stripes means a distance between width centers of the two adjacent second stripes along the length direction of the negative electrode plate unwound.

In one or more embodiments, 0.4≤A₁≤30. For example, the value of A₁ may be 0.4, 0.5, 0.8, 1, 3, 5, 8, 10, 12, 15, 18, 20, 22, 25, 28, 30, or a value falling within a range formed by any two thereof. By controlling the value of A₁ to fall within the above range, the circulation of the electrolyte solution on the negative electrode plate is facilitated, and the electrolyte solution can easily flow to the inner turn of the negative electrode plate, thereby improving the infiltration effect of the electrolyte solution for the negative electrode plate, improving the infiltration performance of the electrolyte solution for the negative electrode plate, also reducing the processing difficulty of the grooving process and the risk of local collapse of the first negative electrode material layer, and in turn, improving the lithium plating suppression performance and cycle performance of the columnar secondary battery.

In one or more embodiments, as shown in FIG. 3, along the length direction (X direction) of the negative electrode plate 20 unwound, the width of a single first stripe 221 is W₁ μm, and the width of a single second stripe 222 is W₂ μm, satisfying: 0.1≤W₁/W₂≤1.5, and 70≤W₂≤120. Optionally, 0.6≤W₁/W₂≤1.2. For example, the value of W₁/W₂ may be 0.1, 0.2, 0.3, 0.4, 0.5, 0.6, 0.7, 0.8, 0.9, 1, 1.1, 1.2, 1.3, 1.4, 1.5, or a value falling within a range formed by any two thereof; and the value of W₂ may be 70, 72, 75, 78, 80, 82, 85, 88, 90, 92, 95, 98, 100, 102, 105, 108, 110, 112, 115, 118, 120, or a value falling within a range formed by any two thereof. By controlling the values of W₁/W₂ and W₂ to fall within the above ranges, the circulation of the electrolyte solution on the negative electrode plate, especially at the inner turn of the negative electrode plate, is facilitated, the risk of insufficient infiltration of the electrolyte solution for the negative electrode plate is reduced, and the infiltration effect of the electrolyte solution for the negative electrode plate is improved. In addition, the above settings reduce the processing difficulty and the risk of lithium plating on the anode-electrolyte interface caused by insufficiency of the CB value due to an excessive loss of the negative active material at the inner turn of the negative electrode plate, thereby not only ensuring a desirable energy density, but also improving the lithium plating suppression performance and cycle performance of the columnar secondary battery.

In one or more embodiments, 7≤W₁≤180. For example, the value of W₁ may be 7, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, or a value falling within a range formed by any two thereof. By controlling the value of W₁ to fall within the above range, the circulation of the electrolyte solution on the negative electrode plate, especially at the inner turn of the negative electrode plate, is facilitated, the risk of insufficient infiltration of the electrolyte solution for the negative electrode plate is reduced, and the infiltration effect of the electrolyte solution for the negative electrode plate is improved. In addition, the above settings reduce the processing difficulty and the risk of lithium plating on the anode-electrolyte interface caused by insufficiency of the CB value due to an excessive loss of the negative active material at the inner turn of the negative electrode plate, thereby not only ensuring a desirable energy density, but also improving the lithium plating suppression performance and cycle performance of the columnar secondary battery.

In one or more embodiments, along the width direction of the negative electrode plate unwound, a ratio of a length of a single first stripe to a width of the first negative electrode material layer is P₁, satisfying: 0.2≤P₁≤1; or, a ratio of a length of a single second stripe to a width of the first negative electrode material layer is P₂, satisfying: 0.2≤P₂≤1. Optionally, 0.3≤P₁≤0.8; and 0.3≤P₂≤0.8. For example, the value of P₁ may be 0.2, 0.3, 0.4, 0.5, 0.6, 0.7, 0.8, 0.9, 1, or a value falling within a range formed by any two thereof; and the value of P₂ may be 0.2, 0.3, 0.4, 0.5, 0.6, 0.7, 0.8, 0.9, 1, or a value falling within a range formed by any two thereof. By controlling the values of P₁ and P₂ to fall within the above ranges, the circulation of the electrolyte solution on the first negative electrode material layer is facilitated, thereby reducing the risk of insufficient infiltration of the electrolyte solution for the negative electrode plate, especially for the middle of the negative electrode plate along the width direction of the negative electrode plate unwound, and effectively improving the infiltration performance of the electrolyte solution for the negative electrode plate. In addition, the above settings reduce the processing difficulty in an actual production process, and reduce the risk of lithium plating on the anode-electrolyte interface caused by an excessive loss of the content of the negative active material in the first negative electrode material layer, thereby improving the lithium plating suppression performance and cycle performance of the columnar secondary battery.

In this application, the negative electrode plate may further include a second negative electrode material layer. As shown in FIG. 1, the negative electrode plate 20 further includes a second negative electrode material layer 23. The second negative electrode material layer 23 is disposed on a surface facing the winding center of the electrode assembly 001. The “surface” here may be the entire surface region of the negative current collector, or a partial surface region of the negative current collector, without being particularly limited herein, as long as the objectives of the application can be achieved. In one or more embodiments, the second negative electrode material layer is provided with a plurality of fourth stripes. The plurality of fourth stripes extend along the width direction of the negative electrode plate unwound and are spaced apart along the length direction of the negative electrode plate unwound. In one or more embodiments, as shown in FIG. 4, along the thickness direction of the negative electrode plate 20, the thickness of the second negative electrode material layer is H′₀ μm, and an average depth of the plurality of fourth stripes is H₄ μm, satisfying: 0.15≤ H₄/H′₀≤0.7, and 50≤H′₀≤100. In one or more embodiments, along the width direction of the negative electrode plate unwound, a ratio of the length of a single third stripe to the width of the second negative electrode material layer is P₄, satisfying: 0.2≤P₄≤1. In one or more embodiments, as shown in FIG. 4, along the length direction (X direction) of the negative electrode plate 20 unwound, the width of a single fourth stripe 231 is W₄ μm, satisfying: 70≤ W₄≤120. In one or more embodiments, as shown in FIG. 4, along the length direction (X direction) of the negative electrode plate 20 unwound, the spacing between two adjacent fourth stripes 231 is A₄ mm, satisfying: 2≤A₄≤10. The above arrangement improves the infiltration effect of the electrolyte solution for the second negative electrode material layer. The stripe arrangement that differs between the first negative electrode material layer and the second negative electrode material layer enables the electrolyte solution to produce a good infiltration effect on the negative electrode plate, and reduces the risk of lithium plating on the negative electrode plate, especially at the inner turn of the negative electrode plate at which the CB value is relatively low (at a position near the winding center of the electrode assembly, or at the winding start section of the negative electrode plate) due to insufficiency of the CB value, thereby improving the lithium plating suppression performance and cycle performance of the columnar secondary battery. In this application, the spacing between two adjacent fourth stripes means a distance between width centers of the two adjacent fourth stripes along the length direction of the negative electrode plate unwound.

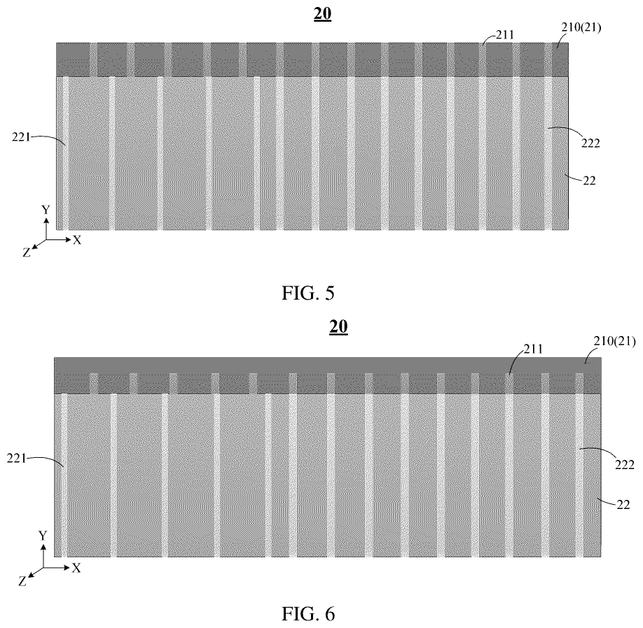

In one or more embodiments, along the width direction of the negative electrode plate unwound, the negative current collector includes a blank foil region connected to the first negative electrode material layer. The blank foil region is provided with a plurality of third stripes. The plurality of third stripes extend along the width direction of the negative electrode plate unwound and are spaced apart along the length direction of the negative electrode plate unwound. As shown in FIG. 5 and FIG. 6, along the width direction (Y direction) of the negative electrode plate 20 unwound, the negative current collector 21 includes a blank foil region 210 connected to the first negative electrode material layer 22. The blank foil region 210 is provided with a plurality of third stripes 211. The plurality of third stripes 211 extend along the width direction (Y direction) of the negative electrode plate unwound and are spaced apart along the length direction (X direction) of the negative electrode plate 20 unwound. By providing the third stripes in the blank foil region, this application provides more electrolyte guide channels for the blank foil region, especially for the flattened part in the blank foil region, thereby improving the diffusion efficiency of the electrolyte solution in the blank foil region. In addition, the third stripes in the blank foil region cause little impact on the capacity of the secondary battery and can effectively reduce the electrochemical impedance. The first stripes, the second stripes, and the third stripes are arranged in coordination to achieve a synergistic effect between the first stripes, the second stripes, and the third stripes, thereby effectively improving the efficiency and performance of infiltration of the electrolyte solution on the negative electrode plate level, improving the consistency of internal resistance on the secondary battery level, and improving the cycle performance and lithium plating suppression performance of the columnar secondary battery.

In one or more embodiments, along the length direction of the negative electrode plate unwound, a center line of a third stripe, a center line of a first stripe, and a center line of a second stripe do not coincide.

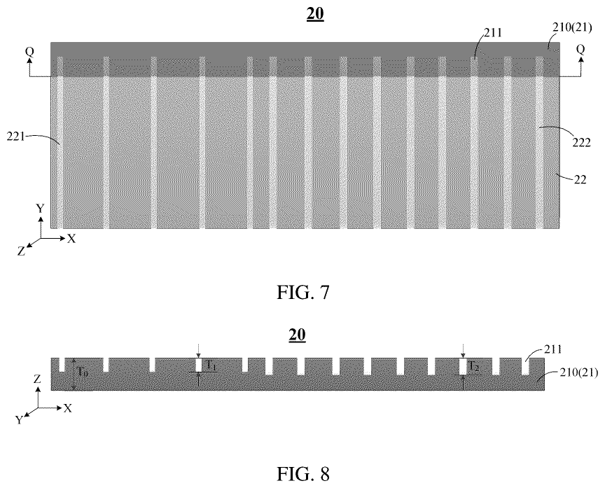

In one or more embodiments, along the length direction of the negative electrode plate unwound, the center lines of only some of the third stripes coincide with the center lines of a plurality of first stripes. In one or more embodiments, along the length direction of the negative electrode plate unwound, the center lines of only some of the third stripes coincide with the center lines of a plurality of second stripes. As shown in FIG. 5 and FIG. 6, along the length direction (X direction) of the negative electrode plate 20 unwound, the center lines of some of the third stripes 211 coincide with the center lines of a plurality of second stripes 222. In one or more embodiments, along the length direction of the negative electrode plate unwound, the center lines of some of the third stripes coincide with the center lines of a plurality of first stripes, and at the same time, the center lines of some of the third stripes coincide with the center lines of a plurality of second stripes. As shown in FIG. 7, along the length direction (X direction) of the negative electrode plate 20 unwound, the center lines of some of the third stripes 211 coincide with the center lines of a plurality of first stripes 221, and at the same time, the center lines of some of the third stripes 211 coincide with the center lines of a plurality of second stripes 222. The above arrangement accelerates the circulation of the electrolyte solution on the negative electrode plate, thereby further improving the infiltration effect of the electrolyte solution for the negative electrode plate, and endowing the columnar secondary battery with higher cycle performance and lithium plating suppression performance.

In one or more embodiments, along the width direction of the negative electrode plate unwound, a ratio of a length of a single third stripe to a width of the blank foil region is P₃, satisfying: 0.1≤P₃≤0.7. Optionally, 0.2≤P₃≤0.5. For example, the value of P₃ may be 0.1, 0.2, 0.3, 0.4, 0.5, 0.6, 0.7, or a value falling within a range formed by any two thereof. By controlling the value of P₃ to fall within the above range, this application facilitates circulation of the electrolyte solution in the blank foil region, improves the infiltration effect of the electrolyte solution for the negative electrode plate, effectively improves the infiltration performance of the electrolyte solution for the negative electrode plate, and reduces the risk that the mechanical properties of the secondary battery are deteriorated by a decrease in the strength of the blank foil region during preparation of the secondary battery, thereby improving the lithium plating suppression performance and cycle performance of the columnar secondary battery while achieving desirable mechanical safety performance.

In one or more embodiments, as shown in FIG. 8, along the thickness direction (Z direction) of the negative electrode plate 20, the thickness of the negative current collector 21 is T₀ μm, the average depth of the plurality of third stripes 211 in a blank foil region 210 opposite to the first section is T₁ μm, and the average depth of the plurality of third stripes 211 in a blank foil region 210 opposite to the second section is T₂ μm, satisfying: 3≤T₀≤20, 0.15≤T₂/T₀≤0.7, and 0.45≤T₁/T₂≤0.95. For example, the value of T₀ may be 3, 4, 5, 6, 7, 8, 9, 10, 11, 12, 13, 14, 15, 16, 17, 18, 19, 20, or a value falling within a range formed by any two thereof; the value of T₂/T₀ may be 0.15, 0.18, 0.2, 0.22, 0.25, 0.28, 0.3, 0.32, 0.35, 0.38, 0.4, 0.42, 0.45, 0.48, 0.5, 0.52, 0.55, 0.58, 0.6, 0.62, 0.65, 0.68, 0.7, or a value falling within a range formed by any two thereof; and the value of T₁/T₂ may be 0.45, 0.48, 0.5, 0.52, 0.55, 0.58, 0.6, 0.62, 0.65, 0.68, 0.7, 0.72, 0.75, 0.78, 0.8, 0.82, 0.85, 0.88, 0.9, 0.92, 0.95, or a value falling within a range formed by any two thereof. By controlling the values of T₁/T₀, T₂/T₀, and T₀ to fall within the above ranges, this application makes it convenient to provide third stripes of different depths in the blank foil region, thereby improving the diffusion efficiency of the electrolyte solution in the blank foil region of the negative current collector, improving the infiltration effect of the electrolyte solution for the negative electrode plate, and additionally, reducing the risk that the blank foil region is struck through by the third stripes during creation of the third stripes in the blank foil region, and improving the cycle performance of the columnar secondary battery while ensuring desirable mechanical safety performance. The method for controlling the thickness T₀ of the negative current collector is not particularly limited herein, as long as the objectives of this application can be achieved. For example, commercially available negative current collectors of different thicknesses may be selected, and the thicknesses of the negative current collectors may be determined with reference to the test method described in the section headed “Test of T₁, T₂, H₁, H₂, T₀, H₀, H₄, H′₀, P₁, P₂, P₃, P₄, W₁, W₂, A₁, A₂, and A₄” in this application, and then the negative current collector of the desired thickness is selected.

The width of a single third stripe is not particularly limited herein, as long as the objectives of this application can be achieved. For example, along the length direction of the negative electrode plate unwound, the width of a single third stripe in the blank foil region opposite to the first section is W′₁ μm, and the width of a single third stripe in the blank foil region opposite to the second section is W′₂ μm, satisfying: 0.1≤W′₁/W′₂≤1.5, and 70≤W′₂≤120. By controlling the values of W′₁/W′₂ and W′₂ to fall within the above ranges, this application facilitates circulation of the electrolyte solution in the blank foil region, improves the diffusion efficiency of the electrolyte solution in the blank foil region, and effectively improves the efficiency and performance of infiltration of the electrolyte solution for the negative electrode plate. In addition, the above settings reduce the processing difficulty in an actual production process, and reduce the safety risk that the mechanical properties of the secondary battery are deteriorated by a decrease in the strength of the blank foil region during preparation of the secondary battery, thereby improving the lithium plating suppression performance and cycle performance of the columnar secondary battery while achieving desirable mechanical safety performance.

The spacing between two adjacent third stripes is not particularly limited herein, as long as the objectives of this application can be achieved. For example, along the length direction of the negative electrode plate unwound, the spacing between two adjacent third stripes in the blank foil region opposite to the first section is A′₁ μm, and the spacing between two adjacent third stripes in the blank foil region opposite to the second section is A′₂ μm, satisfying: 0.2≤A′₁/A′₂≤3, and 2≤A′₂≤10. By controlling the values of A′₁/A′₂ and A′₂ to fall within the above ranges, the circulation of the electrolyte solution in the blank foil region is facilitated, and the infiltration effect of the electrolyte solution for the negative electrode plate is improved. In addition, the above settings can reduce the processing difficulty of a grooving process and the risk of local collapse of the blank foil region, thereby improving the lithium plating suppression performance and cycle performance of the columnar secondary battery while ensuring desirable mechanical safety performance. In this application, the spacing between two adjacent third stripes means a distance between the width centers of the two adjacent third stripes along the length direction of the negative electrode plate unwound.

In this application, the cross-section of a single first stripe, the cross-section of a single second stripe, the cross-section of a single third stripe, and the cross-section of a single fourth stripe mean a plane formed by sectioning the first stripe, the second stripe, the third stripe, and the fourth stripe, respectively, along the length direction of the negative electrode plate unwound and the thickness direction of the stripe (or a cross-section obtained by sectioning the first stripe, the second stripe, the third stripe, and the fourth stripe, respectively, along the length direction and thickness direction of the negative electrode plate unwound). The cross-sectional shapes of a single first stripe, a single second stripe, a single third stripe, and a single fourth stripe are not particularly limited herein, as long as the objectives of this application can be achieved. For example, the cross-sections of a single first stripe, a single second stripe, a single third stripe, and a single fourth stripe each may be at least one independently selected from a triangle, an arcuate shape (the area of the arcuate shape is smaller than the area of a semicircle with the same radius), a semicircle, a rectangle, a trapezoid, or a square.

The cross-sectional shapes obtained by sectioning the first stripe, the second stripe, the third stripe, and the fourth stripe along the length direction and width direction of the negative electrode plate unwound are not particularly limited herein, as long as the objectives of this application can be achieved. For example, the cross-sectional shapes obtained by sectioning the first stripe, the second stripe, the third stripe, and the fourth stripe along the length direction and width direction of the negative electrode plate unwound may be straight lines, curved lines, other specific shapes, or the like. As shown in FIG. 2, FIG. 5, FIG. 6, and FIG. 7, the cross-sectional shapes of the first stripe 221, the second stripe 222, and the third stripe 211 unwound along the length direction (X direction) and the width direction (Y direction) of the negative electrode plate 20 unwound are straight lines.

The negative current collector is not particularly limited herein, as long as the objectives of this application can be achieved. For example, the negative current collector may be copper foil, copper alloy foil, nickel foil, stainless steel foil, titanium foil, foamed nickel, foamed copper, a composite current collector (such as a lithium-copper composite current collector, a carbon-copper composite current collector, a nickel-copper composite current collector, or a titanium-copper composite current collector), or the like. The first negative electrode material layer and the second negative electrode material layer of this application each include a negative active material. The type of the negative active material and the type of the negative active material are not particularly limited herein, as long as the objectives of this application can be achieved. For example, the negative active material may include at least one of natural graphite, artificial graphite, mesocarbon microbeads (MCMB), hard carbon, soft carbon, silicon, a silicon-carbon composite, SiOₓ (0<x≤2), Li—Sn alloy, Li—Sn—O alloy, Sn, SnO, SnO₂, spinel-structured lithium titanium oxide Li₄Ti₅O₁₂, Li—Al alloy, or metallic lithium. The thicknesses of the negative current collector, the first negative electrode material layer, and the second negative electrode material layer are not particularly limited herein, as long as the objectives of this application can be achieved. Optionally, the first negative electrode material layer and the second negative electrode material layer each may further include a conductive agent and a negative electrode binder. The types of the conductive agents in the first negative electrode material layer and the second negative electrode material layer are not particularly limited herein, as long as the objectives of this application can be achieved. For example, the conductive agent may include, but is not limited to, at least one of conductive carbon black (Super P), carbon nanotubes (CNTs), carbon fibers, flake graphite, Ketjen black, graphene, a metal material, or a conductive polymer. The carbon nanotubes may include, but are not limited to, single-walled carbon nanotubes and/or multi-walled carbon nanotubes. The carbon fibers may include, but are not limited to, vapor grown carbon fibers (VGCF) and/or carbon nanofibers. The metal material may include, but is not limited to, metal powder and/or metal fibers. Specifically, the metal may include, but is not limited to, at least one of copper, nickel, aluminum, or silver. The conductive polymer may include, but is not limited to, at least one of polyphenylene derivatives, polyaniline, polythiophene, polyacetylene, or polypyrrole. The types of the negative electrode binders in the first negative electrode material layer and the second negative electrode material layer are not particularly limited herein, as long as the objectives of this application can be achieved. For example, the negative electrode binder may include, but is not limited to, at least one of polyvinylidene fluoride, poly(vinylidene fluoride-co-hexafluoropropylene), polyamide, polyacrylonitrile, polyacrylate, polyacrylic acid, polyacrylic acid sodium salt, polyvinylpyrrolidone, polyvinyl ether, methyl polymethacrylate, polytetrafluoroethylene, or polyhexafluoropropylene. The mass ratio between the negative active material, conductive agent, and negative electrode binder in the first negative electrode material layer and the second negative electrode material layer is not particularly limited herein, as long as the objectives of this application can be achieved.

The method for preparing the negative electrode plate is not particularly limited herein, as long as the objectives of this application can be achieved. For example, a preparation method for the negative electrode plate may include, but is not limited to, the following steps: (1) mixing a negative active material, a negative electrode binder, and a conductive agent, adding a solvent, and stirring well to formulate a negative electrode slurry; (2) predetermining a surface of the negative current collector facing away from the winding center of the electrode assembly, applying the negative electrode slurry onto the surface of the negative current collector facing away from the winding center of the electrode assembly, and oven-drying the slurry to obtain a negative electrode plate coated with a first negative electrode material layer; and (3) performing cold-pressing and slitting, and then along the width direction of the negative electrode plate unwound and along the winding direction of the electrode assembly, determining a first section and a second section of the first negative electrode material layer, providing first stripes on the first section and providing second stripes on the second section to obtain a negative electrode plate.

In one or more embodiments, after step (2), the negative electrode slurry is applied onto the other surface of the negative current collector and oven-dried to obtain a negative electrode plate coated with the first negative electrode material layer and the second negative electrode material layer. In one or more embodiments, in step (3), along the width direction of the negative electrode plate unwound, a blank foil region of the negative current collector, which is connected to the first negative electrode material layer, is determined. The first stripes are provided on the first section, the second stripes are provided on the second section, and at the same time, the third stripes are provided in the blank foil region. In one or more embodiments, in step (3), the first stripes are provided on the first section, the second stripes are provided on the second section, and at the same time, fourth stripes are provided on the second negative electrode material layer. In one or more embodiments, in step (3), the first stripes are provided on the first section, the second stripes are provided on the second section, and at the same time, the third stripes are provided in the blank foil region and the fourth stripes are provided on the second negative electrode material layer.

The solid content of the slurry is not particularly limited herein, as long as the objectives of this application can be achieved. The oven-drying temperature and time are not particularly limited herein, as long as the objectives of this application can be achieved. The process parameters for the cold-pressing and slitting are not particularly limited herein, as long as the objectives of this application can be achieved. The methods for providing the first stripes, the second stripes, the third stripes, and the fourth stripes are not particularly limited herein, as long as the objectives of this application can be achieved. For example, the first stripes, the second stripes, the third stripes, and the fourth stripes may be provided by pulse laser etching. The average depth of the plurality of first stripes in the first section denoted as H₁, the average depth of the plurality of second stripes in the second section denoted as H₂, the average depth of the plurality of third stripes in the blank foil region opposite to the first section denoted as T₁ μm, the average depth of the plurality of third stripes in the blank foil region opposite to the second section denoted as T₂ μm, the average depth of the plurality of fourth stripes denoted as H₄, the width of a single first stripe denoted as W₁, the width of a single second stripe denoted as W₂, the width of a single third stripe denoted as W′, and the width of a single fourth stripe denoted as W₄ may be adjusted and controlled by using a power and a defocus amount of a pulsed laser emitter. The ratio of the length of a single first stripe to the width of the first negative electrode material layer, denoted as P₁, and the ratio of the length of a single second stripe to the width of the first negative electrode material layer, denoted as P₂, may be adjusted and controlled by adjusting the width of the first negative electrode material layer as well as the power and defocus amount of the pulsed laser emitter. The ratio of the length of a single third stripe to the width of the blank foil region, denoted as P₃, may be adjusted and controlled by adjusting the width of the blank foil region as well as the power and defocus amount of the pulsed laser emitter. The ratio of the length of a single fourth stripe to the width of the second negative electrode material layer, denoted as P₄, may be adjusted and controlled by adjusting the width of the second negative electrode material layer as well as the power and defocus amount of the pulsed laser emitter. The spacing A₁ between two adjacent first stripes, the spacing A₂ between two adjacent second stripes, the spacing A′ between two adjacent third stripes, and the spacing A₄ between two adjacent fourth stripes may be adjusted and controlled by adjusting a spacing between pulsed laser emitters or a laser emission frequency.

In this application, different features of the stripes included in the negative electrode plate may be combined, and all the implementations or embodiments covered by the combination fall within the protection scope of this application.

The positive electrode plate is not particularly limited herein, as long as the objectives of this application can be achieved. For example, the positive electrode plate includes a positive current collector and a positive electrode material layer disposed on at least one surface of the positive current collector. The “positive electrode material layer disposed on at least one surface of the positive current collector” means that the positive electrode material layer may be disposed on one surface of the positive current collector or on both surfaces of the positive current collector along the thickness direction of the current collector. It is hereby noted that the “surface” here may be the entire region of the surface of the positive current collector, or a partial region of the surface of the positive current collector, without being particularly limited herein, as long as the objectives of the application can be achieved. As shown in FIG. 1, a positive electrode plate 10 includes a positive current collector 11 and a positive electrode material layer 12 disposed on both surfaces of the positive current collector 11. The positive current collector is not particularly limited herein, as long as the objectives of this application can be achieved. For example, the positive current collector may include aluminum foil, aluminum alloy foil, a composite current collector (such as an aluminum carbon composite current collector), or the like. The positive electrode material layer of this application includes a positive active material. The type of the positive active material is not particularly limited herein, as long as the objectives of this application can be achieved. For example, the positive active material may include at least one of lithium nickel cobalt manganese oxide (LiNi_{0.90}Co_{0.05}Mn_{0.05}O₂ (NCM955), NCM811, NCM622, NCM523, NCM111), lithium nickel cobalt aluminum oxide, lithium iron phosphate, a lithium-rich manganese-based material, lithium cobalt oxide (LiCoO₂), lithium manganese oxide, lithium manganese iron phosphate, lithium titanium oxide, or the like. In this application, the positive active material may further include a non-metal element. For example, the non-metal element includes at least one of fluorine, phosphorus, boron, chlorine, silicon, or sulfur. The thicknesses of the positive current collector and the positive electrode material layer are not particularly limited herein, as long as the objectives of this application can be achieved. In this application, the positive electrode material layer may further include a positive electrode binder and a conductive agent. The type of the positive electrode binder in the positive electrode material layer is not particularly limited herein, as long as the objectives of this application can be achieved. For example, the positive electrode binder may be of the same type as the negative electrode binders in the first negative electrode material layer and the second negative electrode material layer. The type of the conductive agent in the positive electrode material layer is not particularly limited herein, as long as the objectives of this application can be achieved. For example, the conductive agent may be of the same type as the conductive agents in the first negative electrode material layer and the second negative electrode material layer. The mass ratio between the positive active material, the conductive agent, and the positive electrode binder in the positive electrode material layer is not particularly limited herein, and may be selected by a person skilled in the art as actually required, as long as the objectives of this application can be achieved.

The columnar secondary battery in this application includes an electrolyte solution. The electrolyte solution includes a lithium salt and a nonaqueous solvent. The lithium salt may include at least one of LiPF₆, LiNO₃, LiBF₄, LiClO₄, LiB(C₆H₅)₄, LiCH₃SO₃, LiCF₃SO₃, LiN(SO₂CF₃)₂, LiC(SO₂CF₃)₃, Li₂SiF₆, lithium bis(oxalato) borate (LiBOB), lithium bis(trifluoromethanesulfonyl)imide (LiTFSI), or lithium difluoroborate. The content of the lithium salt in the electrolyte solution is not particularly limited herein, as long as the objectives of this application can be achieved. The nonaqueous solvent is not particularly limited herein, as long as the objectives of this application can be achieved. For example, the nonaqueous solvent includes, but is not limited to, at least one of a carbonate ester compound, a carboxylate ester compound, an ether compound, or other organic solvents. The carbonate ester compound may include, but is not limited to, at least one of a chain carbonate ester compound, a cyclic carbonate ester compound, or a fluorocarbonate ester compound. The chain carbonate ester compound may include, but is not limited to, at least one of dimethyl carbonate, diethyl carbonate, dipropyl carbonate, methyl propyl carbonate, ethylene propyl carbonate, or ethyl methyl carbonate. The cyclic carbonate ester compound may include, but is not limited to, at least one of ethylene carbonate, propylene carbonate (PC), butylene carbonate, or vinyl ethylene carbonate. The fluorocarbonate ester compound may include, but is not limited to, at least one of fluoroethylene carbonate, 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, or trifluoromethyl ethylene carbonate. The carboxylate ester compound may include, but is not limited to, at least one of methyl formate, methyl acetate, ethyl acetate, n-propyl acetate, tert-butyl acetate, methyl propionate, ethyl propionate, propyl propionate, γ-butyrolactone, decanolactone, valerolactone, or caprolactone. The ether compound may include, but is not limited to, at least one of dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The above-mentioned other organic solvents may include, but are not limited to, at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate.

The separator is not particularly limited herein as long as the objectives of this application can be achieved. For example, the separator may be made of a material including, but not limited to, at least one of polyethylene (PE)-based, polypropylene (PP)-based polyolefin (PO) separator, polyester (such as polyethylene terephthalate (PET) film), cellulose, polyimide (PI), polyamide (PA), spandex, or aramid. The type of the separator may include a woven film, a nonwoven film, a microporous film, a composite film, a calendered film, or a spinning film. The separator of this application may assume a porous structure. The pore size of the porous structure of the separator is not particularly limited herein, as long as the objectives of this application can be achieved. For example, the pore size may be 0.01 μm to 1 μm. The thickness of the separator is not particularly limited herein, as long as the objectives of this application can be achieved. For example, the thickness of the separator may be 5 μm to 40 μm.

The columnar secondary battery of this application further includes a housing. The housing is configured to accommodate a positive electrode plate, a negative electrode plate, a separator, an electrolyte solution, and other components known in the art for use in a columnar secondary battery. Such other components are not limited herein. The housing is not particularly limited herein, and may be a housing well-known in the art, as long as the objectives of this application can be achieved.

The columnar secondary battery is not particularly limited herein, and may be any device in which an electrochemical reaction occurs. In one or more embodiments, the columnar secondary battery may be, but is not limited to, a lithium-ion secondary battery (lithium-ion battery), a lithium polymer secondary battery, a lithium-ion polymer secondary battery, or the like.

The method for preparing the columnar secondary battery is not particularly limited herein, and may be any preparation method well-known in the art, as long as the objectives of this application can be achieved. For example, a method for preparing the columnar secondary battery includes, but is not limited to, the following steps: stacking the separator, the negative electrode plate, the separator, and the positive electrode plate in sequence, and performing operations such as winding and folding as required on the stacked structure to obtain a jelly-roll electrode assembly; putting the electrode assembly into a housing, welding a current collector disk, assembling an insulation sheet, and then injecting an electrolyte solution into the housing, and sealing the housing to obtain a columnar secondary battery.

A second aspect of this application provides an electronic device. The electronic device includes the columnar secondary battery disclosed in any one of the preceding embodiments. The columnar secondary battery of this application exhibits good cycle performance and lithium plating suppression performance. Therefore, the electronic device of this application achieves a long service life.

The electronic device is not particularly limited herein, and may be any electronic device known in the prior art. For example, the electronic device may include, but is not limited to, a laptop computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, or lithium-ion capacitor.

### EMBODIMENTS

The implementations of this application are described below in more detail with reference to some embodiments and comparative embodiments. Various tests and evaluations are performed by the following methods. In addition, unless otherwise specified, the word “parts” means parts by mass, and the symbol “%” means a percentage by mass.

### Test Methods and Devices

Test of T₁, T₂, H₁, H₂, T₀, H₀, H₄, H′₀, P₁, P₂, P₃, P₄, W₁, W₂, A₁, A₂, and A₄

Discharging a lithium-ion battery at a current of 0.5C at an ambient temperature of 25° C. until the voltage reaches 2.5 V, and then disassembling the battery and taking out a negative electrode plate. Determining a first negative electrode material layer and a second negative electrode material layer of the negative electrode plate according to the orientation of the negative electrode plate in the electrode assembly. Soaking the negative electrode plate in dimethyl carbonate (DMC) for 20 minutes, and then placing the negative electrode plate in an oven in which the negative electrode plate is subsequently dried at 80° C. for 12 hours to obtain a negative electrode plate sample.

Along the width direction of the negative electrode plate unwound, distinguishing a blank foil region and a coated region of the negative current collector by identifying a junction between the negative current collector and the first negative electrode material layer, where the coated region is coated with the first negative electrode material layer. Determining a dividing line between the blank foil region and the coated region.

Cutting the negative electrode plate along the thickness direction of the negative electrode plate and the dividing line between the blank foil region and the coated region to obtain a longitudinal section of the coated region (a longitudinal section of the region coated with the first negative electrode material layer and the second negative electrode material layer, that is, a section of the negative electrode plate along the P-P direction) and a longitudinal section of the blank foil region (that is, the section of the negative electrode plate along the Q-Q direction). Measuring each of the longitudinal sections by using a scanning electron microscope.

Polishing the section of the negative electrode plate sectioned along the P-P direction by using an ion beam cross-section polisher. Observing the section by using a scanning electron microscope so that a dividing line between the first negative electrode material layer and the negative current collector and a dividing line between the second negative electrode material layer and the negative current collector are clearly visible. Measuring the thickness H₀ of the first negative electrode material layer along the thickness direction of the negative electrode plate. Determining first stripes and second stripes according to the change in the depth of the stripes along the thickness direction of the negative electrode plate, and then determining a first section and a second section of the first negative electrode material layer, where the stripe with a greater depth is a second stripe. Selecting 5 first stripes in the first section randomly, and identifying two ends and a midpoint position of each single first stripe in the first section along the width direction of the negative electrode plate unwound. Subsequently, along the thickness direction of the negative electrode plate, measuring the distance from the surface to the bottom surface of the first negative electrode material layer at the two ends and the midpoint position of each single first stripe in the first section, and averaging out the measured values to obtain a depth of a single first stripe in the first section. Averaging out the depths of the 5 first stripes in the first section to obtain an average depth H₁ of a plurality of first stripes in the first section. Selecting 5 second stripes in the second section randomly, and identifying two ends and a midpoint position of each single second stripe in the second section along the width direction of the negative electrode plate unwound. Subsequently, along the thickness direction of the negative electrode plate, measuring the distance from the surface to the bottom surface of the first negative electrode material layer at the two ends and the midpoint position of each single second stripe in the second section, and averaging out the measured values to obtain a depth of a single second stripe in the second section. Averaging out the depths of the 5 second stripes in the second section to obtain an average depth H₂ of a plurality of second stripes in the second section. Selecting a single first stripe in the first section randomly, selecting 5 positions on the stripe along the width direction of the negative electrode plate unwound, and then measuring the width of the stripe at the 5 selected positions on the stripe along the length direction of the negative electrode plate unwound. Averaging out the measured values to obtain a width W₁ of a single first stripe. Measuring a distance between the width center of a single first stripe and the width center of an adjacent first stripe along the length direction of the negative electrode plate unwound, selecting 5 positions to measure the distance once separately, and averaging out the measured values to obtain a spacing A₁ between two adjacent first stripes. Selecting 5 positions randomly on a single second stripe in the second section along the width direction of the negative electrode plate unwound, and measuring the width of the stripe at the 5 selected positions on the stripe along the length direction of the negative electrode plate unwound. Averaging out the measured values to obtain a width W₂ of a single second stripe. Measuring a distance between the width center of a single second stripe and the width center of an adjacent second stripe along the length direction of the negative electrode plate unwound, and selecting 5 positions to measure the distance once separately, averaging out these measured values to obtain a spacing A₂ between two adjacent second stripes.

Measuring, along the width direction of the negative electrode plate, the width of the first negative electrode material layer, and then selecting a single first stripe in the first section randomly and measuring the length of the stripe to obtain the length of a single first stripe. Dividing the length of a single first stripe by the width of the first negative electrode material layer to obtain a ratio P₁ of the length of a single first stripe to the width of the first negative electrode material layer. Selecting a single second stripe in the second section randomly, and measuring the length of the stripe along the width direction of the negative electrode plate to obtain the length of a single second stripe. Dividing the length of a single second stripe by the width of the first negative electrode material layer to obtain a ratio P₂ of the length of a single second stripe to the width of the first negative electrode material layer.

With the first negative electrode material layer replaced with the second negative electrode material layer, the thickness H′₀ of the second negative electrode material layer and H₄, P₄, W₄, and A₄ of the fourth stripe can be obtained according to the above test method.

Polishing the longitudinal section of the blank foil region by using an ion beam cross-section polisher, and observing the longitudinal section of the blank foil region by using a scanning electron microscope. Measuring the thickness T₀ of the negative current collector along the thickness direction of the negative electrode plate. Determining a blank foil region opposite to each section of the first negative electrode material layer according to the change in the depth of the third stripes along the thickness direction of the negative electrode plate. Selecting 5 third stripes randomly in the blank foil region opposite to the first section, and identifying two ends and a midpoint position of each single third stripe in the blank foil region opposite to the first section along the width direction of the negative electrode plate unwound. Subsequently, along the thickness direction of the negative electrode plate, measuring the distance from the surface to the bottom surface of the blank foil region at the two ends and the midpoint position of each single third stripe in the blank foil region opposite to the first section, and averaging out the measured values to obtain a depth of a single third stripe in the blank foil region opposite to the first section. Averaging out the depths of the 5 third stripes in the blank foil region opposite to the first section to obtain an average depth T₁ of a plurality of third stripes in the blank foil region opposite to the first section. Selecting 5 third stripes randomly in the blank foil region opposite to the second section, and identifying two ends and a midpoint position of each single third stripe in the blank foil region opposite to the second section along the width direction of the negative electrode plate unwound. Subsequently, along the thickness direction of the negative electrode plate, measuring the distance from the surface to the bottom surface of the blank foil region at the two ends and the midpoint position of each single third stripe in the blank foil region opposite to the second section, and averaging out the measured values to obtain a depth of a single third stripe in the blank foil region opposite to the second section. Averaging out the depths of the 5 third stripes in the blank foil region opposite to the second section to obtain an average depth T₂ of a plurality of third stripes in the blank foil region opposite to the second section. Selecting a single third stripe randomly in the blank foil region opposite to the first section, selecting 5 positions on the stripe along the width direction of the negative electrode plate unwound, and then measuring the width of the stripe at the 5 selected positions on the stripe along the length direction of the negative electrode plate unwound. Averaging out the measured values to obtain a width of a single third stripe. Measuring, along the length direction of the negative electrode plate unwound, the distance between the width center of a single third stripe and the width center of an adjacent third stripe. Selecting 5 positions to measure the distance once separately, and averaging out these measured values to obtain a spacing between two adjacent third stripes in the blank foil region opposite to the first section. Selecting a single third stripe randomly in the blank foil region opposite to the second section. Selecting 5 positions randomly on the stripe along the width direction of the negative electrode plate unwound, and measuring the width of the stripe at the 5 selected positions on the stripe along the length direction of the negative electrode plate unwound. Averaging out the measured values to obtain a width of a single third stripe. Measuring a distance between the width center of a single third stripe and the width center of an adjacent third stripe along the length direction of the negative electrode plate unwound, selecting 5 positions to measure the distance once separately, and averaging out the measured values to obtain a spacing between two adjacent third stripes in the blank foil region opposite to the second section.

Measuring the width of the blank foil region along the width direction of the negative electrode plate. Selecting a single third stripe randomly in the blank foil region, and measuring the length of the stripe to obtain the length of a single third stripe. Dividing the length of a single third stripe by the width of the blank foil region to obtain a ratio P₃ of the length of a single third stripe to the width of the blank foil region.

### Cycle Performance Test

Performing a charge-and-discharge cycle test on a lithium-ion battery in each embodiment and comparative embodiment in a 25° C. thermostat. Charging the lithium-ion battery at a constant current of 2C until the voltage reaches 4.2 V, and then charging the battery at a constant voltage of 4.2 V until the current tapers off to 0.05C. Leaving the battery to stand for 5 minutes, and then discharging the battery at a constant current of 6C until the voltage drops to 2.5 V, thereby completing a first cycle. Recording the discharge capacity at this time as a first-cycle discharge capacity C₁. Repeating the above process for 600 cycles, and then recording the discharge capacity of the lithium-ion battery as C₆₀₀. Calculating the cycle capacity retention rate at the end of the 600^{th} cycle as a metric for evaluating the infiltration effect for the negative electrode plate and for evaluating the cycle performance of the lithium-ion battery. The calculation formula is Formula (I). A lower 600^{th}-cycle capacity retention rate indicates a worse infiltration effect for the negative electrode plate in the lithium-ion battery and lower cycle performance of the lithium-ion battery. A higher 600^{th}-cycle capacity retention rate indicates a better infiltration effect for the negative electrode plate in the lithium-ion battery and higher cycle performance of the lithium-ion battery.

$${600}^{th} - cycle capacity retention rate ( \% ) = {C}_{600} / {C}_{1} \times 100 \% . \qquad ( I )$$

### Lithium Plating Test

Leaving a lithium-ion battery in each embodiment and comparative embodiment to stand in a 10° C. thermostat for 60 minutes, and then charging the lithium-ion battery at a constant current of 2C until the voltage reaches 4.2 V, and then charging the battery at a constant voltage of 4.2 V until the current tapers off to 0.05C. Leaving the battery to stand for 5 minutes, and then discharging the battery at a constant current of 0.5C until the voltage drops to 2.5 V, thereby completing one cycle. Repeating the above charge-and-discharge process for 10 cycles, and then charging the battery at a constant current of 2C until the voltage reaches 4.2 V, and then charging the battery at constant voltage of 4.2 V until the current tapers off to 0.05 C. Leaving the battery to stand for 5 minutes. Disassembling the lithium-ion battery, and observing the lithium plating status on the surface of the first negative electrode material layer of the negative electrode plate. The surface region without lithium plating is golden yellow, and the lithium plating region is grayish white.

The criteria for determining the degree of lithium plating in the lithium-ion battery are as follows: a lithium plating area 0% means no lithium plating, indicating that the degree of lithium plating is none; a lithium plating area greater than 0 and less than or equal to 2% means slight lithium plating, indicating that the degree of lithium plating is slight; a lithium plating area greater than 2% and less than or equal to 20% means moderate lithium plating, indicating that the degree of lithium plating is moderate; a lithium plating area greater than 20% and less than or equal to 100% means severe lithium plating, indicating that the degree of lithium plating is severe. The percentage of the lithium plating area is calculated based on the total area of the negative electrode material layer.

In this application, a person skilled in the art understands that “C” means a rated capacity of a finished lithium-ion battery delivered from a factory. “1C” means a current rate at which the lithium-ion battery can be fully discharged within 1 hour, “0.1C” means a current rate at which the lithium-ion battery can be fully discharged within 10 hour, and other C-rate values are understood in the same way.

### Embodiment 1-1

### <Preparing a Negative Electrode Plate>

Mixing artificial graphite as a negative active material, sodium carboxymethyl cellulose (CMC-Na), and styrene-butadiene rubber (SBR) at a mass ratio of 97:1.7:1.3, and then adding deionized water as a solvent. Stirring well to obtain a negative electrode slurry in which the solid content is 50 wt %. Applying the negative electrode slurry evenly onto one surface of negative current collector copper foil with a thickness T₀ of 10 μm, and then drying the slurry at 105° C. to obtain a negative electrode plate coated with a first negative electrode material layer on a single side. Subsequently, repeating the above steps on the other surface of the negative current collector copper foil to obtain a negative electrode plate coated with both the first negative electrode material layer and a second negative electrode material layer. Cold-pressing and slitting the negative electrode plate, and then determining a blank foil region of the negative current collector along the width direction of the negative electrode plate unwound. The coating weight of the negative electrode material layer is 107 mg/1540.25 mm², and the thickness of both the first negative electrode material layer and the second negative electrode material layer is H₀=70 μm. Along the width direction of the negative electrode plate unwound, the width of the blank foil region is 5.45 mm, the width of the first negative electrode material layer is 62 mm, and the width of the second negative electrode material layer is 62 mm.

Determining a first section and a second section of the first negative electrode material layer along the length direction of the negative electrode plate unwound. Based on the length of the first negative electrode material layer unwound, the length of the first section accounts for a proportion K₁ of 40%, and the length of the second section accounts for a proportion K₂ of 60%. Providing first stripes on the first section, and providing second stripes on the second section, where the specific shapes of the first stripes and the second stripes are shown in FIG. 2. Along the width direction of the negative electrode plate unwound, setting a ratio P₂ of the length of a single second stripe to the width of the first negative electrode material layer to 0.6, and setting the width W₂ of the second stripe to 100 μm. Along the length direction of the negative electrode plate unwound, setting the spacing A₂ between two adjacent second stripes to 5 mm, setting the average depth H₂ of a plurality of second stripes in the second section to 35 μm, and setting H₂/H₀ to 0.5. Along the width direction of the negative electrode plate unwound, setting the ratio PI of the length of a single first stripe to the width of the first negative electrode material layer to 0.6, and setting the width W₁ of the first stripe to 90 μm. Along the length direction of the negative electrode plate unwound, setting the spacing A₁ between two adjacent first stripes to 5 mm, setting the average depth H₁ of a plurality of first stripes in the first section to 28 μm, setting H₁/H₂ to 0.8, setting A₁/A₂ to 1, and setting W₁/W₂ to 0.9. Laser-etching the first stripes on the first section, and laser-etching the second stripes on the second section according to the above parameters.

Setting the average depth H₄ of the fourth stripes to 35 μm, and setting H₄/H′₀ to 0.5. Along the width direction of the negative electrode plate unwound, setting the ratio P₄ of the length of a single fourth stripe to the width of the second negative electrode material layer to 0.6, and setting the width W₄ of the fourth stripe to 100 μm. Along the length direction of the negative electrode plate unwound, setting the spacing A₄ between two adjacent fourth stripes to 5 mm. The shape of the fourth stripe is the same as that of the second stripe. Laser-etching the fourth stripes on the second negative electrode material layer according to the above parameters.

Finally, a negative electrode plate of 67.45 mm×1436 mm in size is obtained.

### <Preparing a Positive Electrode Plate>

Mixing lithium nickel cobalt manganese oxide (LiNi_{0.8}Co_{0.1}Mn_{0.1}O₂) as a positive active material, polyvinylidene fluoride (PVDF) as a binder, and conductive carbon black at a mass ratio of 94.8:2.8:2.4, and dispersing the constituents in an N-methyl-pyrrolidone (NMP) solvent. Stirring well to obtain a positive electrode slurry in which the solid content is 72 wt %. Coating one surface of 15 μm-thick positive current collector aluminum foil with the positive electrode slurry evenly, and drying the slurry at 105° C. to obtain a positive electrode plate coated with a positive electrode material layer on a single side. Subsequently, repeating the above steps on the other surface of the positive current collector aluminum foil to obtain a positive electrode plate coated with the positive electrode material layer on both sides. Subsequently, performing cold-pressing, cutting, and slitting, and drying the electrode plate in an 105° C. vacuum for 4 hours to obtain a positive electrode plate of 64.5 mm×1422 mm in size ready for use. The coating weight of the positive electrode material layer is 234 mg/1540.25 mm², and the compaction density of the positive electrode material layer is 3.4 g/cm³. The width of the positive electrode material layer is 60 mm, and the width of the blank foil region of the positive electrode plate is 4.5 mm.

### <Separator>

Using a 12 μm-thick polyethylene (PE) film as a separator.

### <Preparing an Electrolyte Solution>

Mixing ethylene carbonate (EC), ethyl methyl carbonate (EMC), and diethyl carbonate (DEC) at a mass ratio of 30:50:20 in an dry argon atmosphere glovebox to form an organic solvent (base solvent), and then adding hexafluorophosphate (LiPF₆) as a lithium salt into the base solvent, and stirring to obtain an electrolyte solution. Based on the mass of the electrolyte solution, the mass percent of LiPF₆ is 12.5%, and the remainder is the base solvent.

### <Preparing a Lithium-Ion Battery>

Stacking the above-prepared separator, negative electrode plate, separator, and positive electrode plate sequentially, and pre-winding the stacked structure to ensure the following configurations: the separator is located between the negative electrode and the positive electrode, the first negative electrode material layer faces away from the center of the electrode assembly formed by the pre-winding, and the first section of the first negative electrode material layer is located near the center of the electrode assembly formed by the pre-winding. Subsequently, winding and flattening the stacked structure to form an electrode assembly, welding a current collector disk to the electrode assembly, placing the electrode assembly into a housing, performing penetration welding at the bottom of the housing, marking the product information on the housing by inkjet-printing, drying the housed electrode assembly in a vacuum, injecting an electrolyte solution, crimp-sealing the housing, leaving the product to stand in a high-temperature environment, and performing chemical formation and capacity grading to obtain a lithium-ion battery, where the chemical formation is performed within an upper-limit voltage of 3.6 V at a temperature of 45° C., and the chemically formed product is left to stand at a normal temperature of 25° C. for 24 hours.

### Embodiments 1-2 to 1-34

Identical to Embodiment 1-1 except that the relevant preparation parameters are adjusted according to Table 1.

### Embodiment 1-35

Identical to Embodiment 1-1 except that the parameters of the stripes in the second negative electrode material layer in <Preparing a negative electrode plate> are exactly the same as the parameters of the stripes in the first negative electrode material layer, that is, except that the first negative electrode material layer is exactly the same as the second negative electrode material layer.

### Embodiment 1-36

Identical to Embodiment 1-1 except that no stripes are provided on the second negative electrode material layer in <Preparing a negative electrode plate>.

### Embodiment 2-1

Identical to Embodiment 1-1 except that third stripes are additionally provided in the blank foil region according to the following steps in <Preparing a negative electrode plate>. Providing third stripes in the blank foil region, where the specific shapes of the third stripes are shown in FIG. 5. The parameters are set as follows: the average depth T′ of the third stripes is 5 μm; the average depth T₁ of a plurality of third stripes in the blank foil region opposite to the first section is 5 μm; the average depth T₂ of a plurality of third stripes in the blank foil region opposite to the second section is 5 μm; T′/T₀ is 0.5; along the width direction of the negative electrode plate unwound, the ratio P₃ of the length of a single third stripe to the width of the blank foil region is 0.3; the width W′₁ of the third stripe in the blank foil region opposite to the first section is 90 μm; the width W′₂ of the third stripe in the blank foil region opposite to the second section is 100 μm; along the length direction of the negative electrode plate unwound, the spacing A′₁ between two adjacent third stripes in the blank foil region opposite to the first section is 5 mm; and the spacing A′₂ between two adjacent third stripes in the blank foil region opposite to the second section is 5 mm. The first stripes are laser-etched on the first section, the second stripes are laser-etched on the second section, and the third stripes are laser-etched in the blank foil region according to the above parameters, so as to obtain a negative electrode plate of 67.45 mm×1436 mm in size.

### Embodiment 2-2

Identical to Embodiment 2-1 except the following parameter settings: the average depth T₂ of the third stripes in the blank foil region opposite to the second section is 5 μm, T₂/T₀ is 0.5, the average depth T₁ of the third stripes in the blank foil region opposite to the first section is 4 μm, and T₁/T₂ is 0.8.

### Embodiments 2-3 to 2-13

Identical to Embodiment 2-2 except that the relevant preparation parameters are adjusted according to Table 2.

### Comparative Embodiment 1

Identical to Embodiment 1-1 except that stripes are provided on neither the first negative electrode material layer nor the second negative electrode material layer in <Preparing a negative electrode plate>.

### Comparative Embodiment 2

Identical to Embodiment 1-1 except that no stripes are provided on the first negative electrode material layer in <Preparing a negative electrode plate>.

### Comparative Embodiments 3 to 4

Identical to Embodiment 1-1 except that the relevant preparation parameters are adjusted according to Table 1 and no stripes are provided on the second negative electrode material layer.

### Comparative Embodiment 5

Identical to Embodiment 1-1 except that only the second stripes are provided in the second section and no stripes are provided on the second negative electrode material layer in <Preparing a negative electrode plate>.

### Comparative Embodiment 6

Identical to Embodiment 1-1 except that only the first stripes are provided in the first section and no stripes are provided on the second negative electrode material layer in <Preparing a negative electrode plate>.

### Comparative Embodiment 7

Identical to Embodiment 1-1 except that the relevant preparation parameters are adjusted according to Table 1 and no stripes are provided on the second negative electrode material layer.

### Comparative Embodiment 8

Identical to Embodiment 1-1 except that the relevant preparation parameters are adjusted according to Table 1.

The preparation parameters and performance parameters of each embodiment and comparative embodiment are shown in Table 1 and Table 2.

TABLE 1

| | K₁ | K₂ | | | H₂ | | H₁ | A₂ | | A₁ |
|---|---|---|---|---|---|---|---|---|---|---|
| | (%) | (%) | H₀(μm) | H₂/H₀ | (μm) | H₁/H₂ | (μm) | (mm) | A₁/A₂ | (mm) |
| Embodiment 1-1 | 40 | 60 | 70 | 0.5 | 35 | 0.8 | 28 | 5 | 1 | 5 |
| Embodiment 1-2 | 9 | 91 | 70 | 0.5 | 35 | 0.8 | 28 | 5 | 1 | 5 |
| Embodiment 1-3 | 17 | 83 | 70 | 0.5 | 35 | 0.8 | 28 | 5 | 1 | 5 |
| Embodiment 1-4 | 50 | 50 | 70 | 0.5 | 35 | 0.8 | 28 | 5 | 1 | 5 |
| Embodiment 1-5 | 60 | 40 | 70 | 0.5 | 35 | 0.8 | 28 | 5 | 1 | 5 |
| Embodiment 1-6 | 75 | 25 | 70 | 0.5 | 35 | 0.8 | 28 | 5 | 1 | 5 |
| Embodiment 1-7 | 40 | 60 | 50 | 0.5 | 25 | 0.8 | 20 | 5 | 1 | 5 |
| Embodiment 1-8 | 40 | 60 | 100 | 0.5 | 50 | 0.8 | 40 | 5 | 1 | 5 |
| Embodiment 1-9 | 40 | 60 | 70 | 0.15 | 10.5 | 0.8 | 8.4 | 5 | 1 | 5 |
| Embodiment 1-10 | 40 | 60 | 70 | 0.3 | 21 | 0.8 | 16.8 | 5 | 1 | 5 |
| Embodiment 1-11 | 40 | 60 | 70 | 0.6 | 42 | 0.8 | 33.6 | 5 | 1 | 5 |
| Embodiment 1-12 | 40 | 60 | 70 | 0.7 | 49 | 0.8 | 39.2 | 5 | 1 | 5 |
| Embodiment 1-13 | 40 | 60 | 70 | 0.5 | 35 | 0.45 | 15.75 | 5 | 1 | 5 |
| Embodiment 1-14 | 40 | 60 | 70 | 0.5 | 35 | 0.7 | 24.5 | 5 | 1 | 5 |
| Embodiment 1-15 | 40 | 60 | 70 | 0.5 | 35 | 0.85 | 29.75 | 5 | 1 | 5 |
| Embodiment 1-16 | 40 | 60 | 70 | 0.5 | 35 | 0.95 | 33.25 | 5 | 1 | 5 |
| Embodiment 1-17 | 40 | 60 | 70 | 0.5 | 35 | 0.8 | 28 | 2 | 1 | 2 |
| Embodiment 1-18 | 40 | 60 | 70 | 0.5 | 35 | 10.8 | 28 | 10 | 1 | 10 |
| Embodiment 1-19 | 40 | 60 | 70 | 0.5 | 35 | 0.8 | 28 | 5 | 0.2 | 1 |
| Embodiment 1-20 | 40 | 60 | 70 | 0.5 | 35 | 0.8 | 28 | 5 | 0.5 | 2.5 |
| Embodiment 1-21 | 140 | 60 | 70 | 0.5 | 35 | 0.8 | 28 | 5 | 1.5 | 7.5 |
| Embodiment 1-22 | 40 | 60 | 70 | 0.5 | 35 | 0.8 | 28 | 5 | 3 | 15 |
| Embodiment 1-23 | 40 | 60 | 70 | 0.5 | 35 | 0.8 | 28 | 5 | 3.5 | 17.5 |
| Embodiment 1-24 | 40 | 60 | 70 | 0.5 | 35 | 0.8 | 28 | 5 | 1 | 5 |
| Embodiment 1-25 | 40 | 60 | 70 | 0.5 | 35 | 0.8 | 28 | 5 | 1 | 5 |
| Embodiment 1-26 | 40 | 60 | 70 | 0.5 | 35 | 0.8 | 28 | 5 | 1 | 5 |
| Embodiment 1-27 | 40 | 60 | 70 | 0.5 | 35 | 0.8 | 28 | 5 | 1 | 5 |
| Embodiment 1-28 | 40 | 60 | 70 | 0.5 | 35 | 0.8 | 28 | 5 | 1 | 5 |
| Embodiment 1-29 | 40 | 60 | 70 | 0.5 | 35 | 0.8 | 28 | 5 | 1 | 5 |
| Embodiment 1-30 | 40 | 60 | 70 | 0.5 | 35 | 0.8 | 28 | 5 | 1 | 5 |
| Embodiment 1-31 | 40 | 60 | 70 | 0.5 | 35 | 0.8 | 28 | 5 | 1 | 5 |
| Embodiment 1-32 | 40 | 60 | 70 | 0.5 | 35 | 0.8 | 28 | 5 | 1 | 5 |
| Embodiment 1-33 | 40 | 60 | 70 | 0.5 | 35 | 0.8 | 28 | 5 | 1 | 5 |
| Embodiment 1-34 | 40 | 60 | 70 | 0.5 | 35 | 0.8 | 28 | 5 | 1 | 5 |
| Embodiment 1-35 | 40 | 60 | 70 | 0.5 | 35 | 0.8 | 28 | 5 | 1 | 5 |
| Embodiment 1-36 | 40 | 60 | 70 | 0.5 | 35 | 0.8 | 28 | 5 | 1 | 5 |
| Comparative | / | / | 70 | / | / | / | / | / | / | / |
| Embodiment 1 | | | | | | | | | | |
| Comparative | / | / | 70 | / | / | / | / | / | / | / |
| Embodiment 2 | | | | | | | | | | |
| Comparative | 0 | 100 | 70 | 0.5 | 35 | / | / | 5 | / | / |
| Embodiment 3 | | | | | | | | | | |
| Comparative | 100 | 0 | 70 | / | / | / | 28 | / | / | 5 |
| Embodiment 4 | | | | | | | | | | |
| Comparative | 40 | 60 | 70 | 0.5 | 35 | / | / | 5 | / | / |
| Embodiment 5 | | | | | | | | | | |
| Comparative | 40 | 60 | 70 | / | / | / | 28 | / | / | 5 |
| Embodiment 6 | | | | | | | | | | |
| Comparative | 40 | 60 | 70 | 0.4 | 28 | 1.25 | 35 | 5 | 1 | 5 |
| Embodiment 7 | | | | | | | | | | |
| Comparative | 0 | 100 | 70 | 0.5 | 35 | / | / | 5 | / | / |
| Embodiment 8 | | | | | | | | | | |

| | W₂ | | W₁ | | | Severity of lithium | 600^{th}-cycle capacity |
|---|---|---|---|---|---|---|---|
| | (μm) | W₁/W₂ | (μm) | P₁ | P₂ | plating | retention rate (%) |
| Embodiment 1-1 | 100 | 0.9 | 90 | 0.6 | 0.6 | No lithium plating | 82.0 |
| Embodiment 1-2 | 100 | 0.9 | 90 | 0.6 | 0.6 | Slight | 79.9 |
| Embodiment 1-3 | 100 | 0.9 | 90 | 0.6 | 0.6 | No lithium plating | 81.5 |
| Embodiment 1-4 | 100 | 0.9 | 90 | 0.6 | 0.6 | No lithium plating | 82.5 |
| Embodiment 1-5 | 100 | 0.9 | 90 | 0.6 | 0.6 | No lithium plating | 83.2 |
| Embodiment 1-6 | 100 | 0.9 | 90 | 0.6 | 0.6 | Slight | 80.7 |
| Embodiment 1-7 | 100 | 0.9 | 90 | 0.6 | 0.6 | No lithium plating | 82.7 |
| Embodiment 1-8 | 100 | 0.9 | 90 | 0.6 | 0.6 | Slight | 80.3 |
| Embodiment 1-9 | 100 | 0.9 | 90 | 0.6 | 0.6 | Slight | 80.4 |
| Embodiment 1-10 | 100 | 0.9 | 90 | 0.6 | 0.6 | No lithium plating | 81.7 |
| Embodiment 1-11 | 100 | 0.9 | 90 | 0.6 | 0.6 | No lithium plating | 82.4 |
| Embodiment 1-12 | 100 | 0.9 | 90 | 0.6 | 0.6 | Slight | 80.5 |
| Embodiment 1-13 | 100 | 0.9 | 90 | 0.6 | 0.6 | No lithium plating | 80.7 |
| Embodiment 1-14 | 100 | 0.9 | 90 | 0.6 | 0.6 | No lithium plating | 81.5 |
| Embodiment 1-15 | 100 | 0.9 | 90 | 0.6 | 0.6 | No lithium plating | 82.5 |
| Embodiment 1-16 | 100 | 0.9 | 90 | 0.6 | 0.6 | No lithium plating | 81.0 |
| Embodiment 1-17 | 100 | 0.9 | 90 | 0.6 | 0.6 | No lithium plating | 81.7 |
| Embodiment 1-18 | 100 | 0.9 | 90 | 0.6 | 0.6 | No lithium plating | 82.8 |
| Embodiment 1-19 | 100 | 0.9 | 90 | 0.6 | 0.6 | No lithium plating | 81.0 |
| Embodiment 1-20 | 100 | 0.9 | 90 | 0.6 | 0.6 | No lithium plating | 81.6 |
| Embodiment 1-21 | 100 | 0.9 | 90 | 0.6 | 0.6 | No lithium plating | 82.8 |
| Embodiment 1-22 | 100 | 0.9 | 90 | 0.6 | 0.6 | No lithium plating | 80.8 |
| Embodiment 1-23 | 100 | 0.9 | 90 | 0.6 | 0.6 | No lithium plating | 80.2 |
| Embodiment 1-24 | 70 | 0.9 | 63 | 0.6 | 0.6 | No lithium plating | 81.8 |
| Embodiment 1-25 | 120 | 0.9 | 108 | 0.6 | 0.6 | No lithium plating | 83.0 |
| Embodiment 1-26 | 100 | 0.1 | 10 | 0.6 | 0.6 | No lithium plating | 79.5 |
| Embodiment 1-27 | 100 | 0.6 | 60 | 0.6 | 0.6 | No lithium plating | 81.1 |
| Embodiment 1-28 | 100 | 1.2 | 120 | 0.6 | 0.6 | No lithium plating | 82.4 |
| Embodiment 1-29 | 100 | 1.5 | 150 | 0.6 | 0.6 | No lithium plating | 79.6 |
| Embodiment 1-30 | 100 | 1.6 | 160 | 0.6 | 0.6 | No lithium plating | 78.5 |
| Embodiment 1-31 | 100 | 0.9 | 90 | 0.2 | 0.2 | No lithium plating | 81.1 |
| Embodiment 1-32 | 100 | 0.9 | 90 | 0.3 | 0.3 | No lithium plating | 81.5 |
| Embodiment 1-33 | 100 | 0.9 | 90 | 0.8 | 0.8 | No lithium plating | 82.8 |
| Embodiment 1-34 | 100 | 0.9 | 90 | 1 | 1 | Slight | 81.3 |
| Embodiment 1-35 | 100 | 0.9 | 90 | 0.6 | 0.6 | No lithium plating | 80.2 |
| Embodiment 1-36 | 100 | 0.9 | 90 | 0.6 | 0.6 | No lithium plating | 72.2 |
| Comparative | / | / | / | / | / | Severe | 64.2 |
| Embodiment 1 | | | | | | | |
| Comparative | / | / | / | / | / | Severe | 68.2 |
| Embodiment 2 | | | | | | | |
| Comparative | 100 | / | / | 0.6 | / | Moderate | 69.3 |
| Embodiment 3 | | | | | | | |
| Comparative | / | / | 90 | / | 0.6 | Moderate | 70.2 |
| Embodiment 4 | | | | | | | |
| Comparative | 100 | / | / | 0.6 | / | Slight | 69.8 |
| Embodiment 5 | | | | | | | |
| Comparative | / | / | 90 | / | 0.6 | Moderate | 70.5 |
| Embodiment 6 | | | | | | | |
| Comparative | 90 | 1.111 | 100 | 0.6 | 0.6 | Severe | 68.5 |
| Embodiment 7 | | | | | | | |
| Comparative | 100 | / | / | 0.6 | / | Moderate | 74.2 |
| Embodiment 8 | | | | | | | |

Note:
“/” in Table 1 represents absence of the relevant preparation parameter.

As can be seen from Embodiments 1-1 to 1-36 and Comparative Embodiments 1 to 8, by controlling the length proportions of the first section and the second section to fall within the ranges specified herein, by providing the first stripes on the first section and providing the second stripes on the second section, and by making the values of H₀, H₂/H₀, and H₁/H₂ fall within the ranges specified herein, the degree of lithium plating of the lithium-ion battery is relatively low, and the 600^{th}-cycle capacity retention rate of the lithium-ion battery is improved, indicating that the electrolyte solution produces a good effect of infiltrating the negative electrode plate of this application, and the lithium-ion battery exhibits good lithium plating suppression performance and cycle performance. In Comparative Embodiment 1, stripes are provided on neither the first negative electrode material layer nor the second negative electrode material layer; in Comparative Embodiment 2, no stripes are provided on the first negative electrode material layer; in Comparative Embodiment 3, the second stripes are solely provided on the first negative electrode material layer; in Comparative embodiment 4, the first stripes are solely provided on the first negative electrode material layer; in Comparative Embodiment 5, only the second stripes are provided on the second section of the first negative electrode material layer; in Comparative Embodiment 6, only the first stripes are provided on the first section of the first negative electrode material layer; in Comparative Embodiment 7, the parameters of the first stripes and the second stripes are opposite to those in Embodiment 1-1; in Comparative Embodiment 8, the second stripes are solely provided on the first negative electrode material layer and stripes are provided on the second negative electrode material layer. For the lithium-ion batteries in Comparative Embodiments 1 to 8, the degree of lithium plating is higher, and/or the 600^{th}-cycle capacity retention rate is lower. By contrast, for the lithium-ion batteries in Embodiments 1-1 to 1-36, the degree of lithium plating is low, and the 600^{th}-cycle capacity retention rate is high, indicating that the electrolyte solutions produce a good infiltration effect on the negative electrode plate, and the lithium-ion batteries exhibit good lithium plating suppression performance and cycle performance.

The values of A₂ and A₁/A₂ typically affect the lithium plating suppression performance and cycle performance of the lithium-ion battery. As can be seen from Embodiment 1-1 and Embodiments 1-17 to 1-23, when the values of A₂ and A₁/A₂ fall within the ranges specified herein, the degree of lithium plating of the lithium-ion battery is low, and the 600^{th}-cycle capacity retention rate is high, indicating that the electrolyte solutions in these embodiments of this application produce a good infiltration effect on the electrode plate, and the lithium-ion battery exhibits good lithium plating suppression performance and cycle performance.

The values of W₂ and W₁/W₂ typically affect the lithium plating suppression performance and cycle performance of the lithium-ion battery. As can be seen from Embodiment 1-1 and Embodiments 1-24 to 1-30, when the values of W₂ and W₁/W₂ fall within the ranges specified herein, the degree of lithium plating of the lithium-ion battery is low, and the 600^{th}-cycle capacity retention rate is high, indicating that the electrolyte solutions in these embodiments of this application produce a good infiltration effect on the electrode plate, and the lithium-ion batteries exhibit good lithium plating suppression performance and cycle performance.

The values of P₁ and P₂ typically affect the lithium plating suppression performance and cycle performance of the lithium-ion battery. As can be seen from Embodiment 1-1 and Embodiments 1-31 to 1-34, when the values of P₁ and P₂ fall within the ranges specified herein, the degree of lithium plating of the lithium-ion battery is low, and the 600^{th}-cycle capacity retention rate is high, indicating that the electrolyte solutions in these embodiments of this application produce a good infiltration effect on the electrode plate, and the lithium-ion batteries exhibit good lithium plating suppression performance and cycle performance.

The arrangement of stripes on the second negative electrode material layer typically affects the lithium plating suppression performance and cycle performance of the lithium-ion battery. As can be seen from Embodiment 1-1 and Embodiments 1-35 to 1-36, when the arrangement of stripes on the second negative electrode material layer falls within the range specified herein, the degree of lithium plating of the lithium-ion battery is low, and the 600^{th}-cycle capacity retention rate is high, indicating that the electrolyte solutions in these embodiments of this application produce a good infiltration effect on the electrode plate, and the lithium-ion batteries exhibit good lithium plating suppression performance and cycle performance.

TABLE 2

| | | T₀ | | T₂ | | T₁ | Severity of lithium | 600^{th}-cycle capacity |
|---|---|---|---|---|---|---|---|---|
| | P₃ | (μm) | T₂/T₀ | (μm) | T₁/T₂ | (μm) | plating | retention rate (%) |
| Embodiment 1-1 | / | 10 | / | / | / | / | No lithium plating | 82.0 |
| Embodiment 2-1 | 0.3 | 10 | 0.5 | 5 | 1 | 5 | No lithium plating | 82.4 |
| Embodiment 2-2 | 0.3 | 10 | 0.5 | 5 | 0.8 | 4 | No lithium plating | 85.1 |
| Embodiment 2-3 | 0.3 | 10 | 0.15 | 1.5 | 0.8 | 1.2 | No lithium plating | 83.9 |
| Embodiment 2-4 | 0.3 | 10 | 0.7 | 7 | 0.8 | 5.6 | No lithium plating | 84.2 |
| Embodiment 2-5 | 0.3 | 10 | 0.5 | 5 | 0.45 | 2.25 | No lithium plating | 84.5 |
| Embodiment 2-6 | 0.3 | 10 | 0.5 | 5 | 0.95 | 4.75 | No lithium plating | 83.1 |
| Embodiment 2-7 | 0.3 | 3 | 0.5 | 1.5 | 0.8 | 1.2 | No lithium plating | 85.5 |
| Embodiment 2-8 | 0.3 | 20 | 0.5 | 10 | 0.8 | 8 | No lithium plating | 84.8 |
| Embodiment 2-9 | 0.1 | 10 | 0.5 | 5 | 0.8 | 4 | No lithium plating | 83.4 |
| Embodiment 2-10 | 0.2 | 10 | 0.5 | 5 | 0.8 | 4 | No lithium plating | 84.1 |
| Embodiment 2-11 | 0.5 | 10 | 0.5 | 5 | 0.8 | 4 | No lithium plating | 86.1 |
| Embodiment 2-12 | 0.7 | 10 | 0.5 | 5 | 0.8 | 4 | No lithium plating | 82.5 |
| Embodiment 2-13 | 0.8 | 10 | 0.5 | 5 | 0.8 | 4 | Slight | 82.2 |

Note:
“/” in Table 2 represents absence of the relevant preparation parameter.

The arrangement of the third stripes typically affects the lithium plating suppression performance and cycle performance of the lithium-ion battery. As can be seen from Embodiment 1-1 and Embodiments 2-1 to 2-13, when the arrangement of the third stripes falls within the range specified herein, the degree of lithium plating of the lithium-ion battery is low, and the 600^{th}-cycle capacity retention rate is high, indicating that the electrolyte solutions in these embodiments of this application produce a good infiltration effect on the electrode plate, and the lithium-ion batteries exhibit good lithium plating suppression performance and cycle performance.

The values of T₂/T₀, T₁/T₂, and T₀ typically affect the lithium plating suppression performance and cycle performance of the lithium-ion battery. As can be seen from Embodiment 1-1 and Embodiments 2-2 to 2-8, when the values of T₂/T₀, T₁/T₂, and T₀ fall within the ranges specified herein, the degree of lithium plating of the lithium-ion battery is low, and the 600^{th}-cycle capacity retention rate is high, indicating that the electrolyte solutions in these embodiments of this application produce a good infiltration effect on the electrode plate, and the lithium-ion batteries exhibit good lithium plating suppression performance and cycle performance.

The value of P₃ typically affects the lithium plating suppression performance and cycle performance of the lithium-ion battery. As can be seen from Embodiment 1-1, Embodiment 2-2, and Embodiments 2-9 to 2-13, when the value of P₃ falls within the range specified herein, the degree of lithium plating of the lithium-ion battery is low, and the 600^{th}-cycle capacity retention rate is high, indicating that the electrolyte solutions in these embodiments of this application produce a good infiltration effect on the electrode plate, and the lithium-ion batteries exhibit good lithium plating suppression performance and cycle performance.

It is hereby noted that the relational terms herein such as “first” and “second” are used merely to differentiate one entity or operation from another, but do not involve or imply any actual relationship or sequence between the entities or operations. Moreover, the terms “include”, “comprise”, and any variation thereof are intended to cover a non-exclusive inclusion relationship by which a process, method, or object that includes or comprises a series of elements not only includes such elements, but also includes other elements not expressly specified or also includes inherent elements of the process, method, or object.

Different embodiments of this application are described in a correlative manner. For the same or similar part in one embodiment, reference may be made to another embodiment. Each embodiment focuses on differences from other embodiments.

Described above are merely preferred embodiments of this application that are not intended to limit this application. Any modifications, equivalent replacements, improvements, and the like made without departing from the concept and principles of this application still fall within the protection scope of this application.

What is claimed is:

1. A columnar secondary battery, comprising an electrode assembly, wherein the electrode assembly comprises a positive electrode plate, a negative electrode plate, and a separator; the negative electrode plate comprises a negative current collector, and a surface of the negative current collector facing away from a winding center of the electrode assembly is coated with a first negative electrode material layer;
along a winding direction of the electrode assembly, the first negative electrode material layer comprises a first section and a second section connected sequentially, and based on a length of the first negative electrode material layer, a length of the first section accounts for 9% to 75%, and a length of the second section accounts for 25% to 91%;
a plurality of first stripes are provided on the first section, the plurality of first stripes extend along a width direction of the negative electrode plate and are spaced apart along a length direction of the negative electrode plate; a plurality of second stripes are provided on the second section, the plurality of second stripes extend along the width direction of the negative electrode plate and are spaced apart along the length direction of the negative electrode plate; along a thickness direction of the negative electrode plate, an average depth of the plurality of first stripes in the first section is H₁ μm, an average depth of the plurality of second stripes in the second section is H₂ μm, and a thickness of the first negative electrode material layer is H₀ μm, 50≤H₀≤100, 0.15≤H₂/H₀≤0.7, and 0.45≤H₁/H₂≤0.95.

2. The columnar secondary battery according to claim 1, wherein, based on the length of the first negative electrode material layer, the length of the first section accounts for 17% to 60%, and the length of the second section accounts for 40% to 83%;
and/or,
$$0.3 \leq {H}_{2} / {H}_{0} \leq 0.6 , and 0.7 \leq {H}_{1} / {H}_{2} \leq 0.85 .$$

3. The columnar secondary battery according to claim 1, wherein, along the length direction of the negative electrode plate, a spacing between two adjacent first stripes is A₁ mm, and a spacing between two adjacent second stripes is A₂ mm, 0.2≤A₁/A₂≤3, and 2≤A₂≤10.

4. The columnar secondary battery according to claim 3, wherein 0.5≤A₁/A₂≤1.5.

5. The columnar secondary battery according to claim 1, wherein, along the length direction of the negative electrode plate, a width of a single first stripe is W₁ μm, and a width of a single second stripe is W₂ μm, 0.1≤W₁/W₂≤1.5, and 70≤W₂≤120.

6. The columnar secondary battery according to claim 5, wherein 0.6≤W₁/W₂≤1.2.

7. The columnar secondary battery according to claim 1, wherein, along the width direction of the negative electrode plate, a ratio of a length of a single first stripe to a width of the first negative electrode material layer is P₁, 0.2≤P₁≤1; or, a ratio of a length of a single second stripe to a width of the first negative electrode material layer is P₂, 0.2≤P₂≤1.

8. The columnar secondary battery according to claim 7, wherein 0.3≤P₁≤0.8; and/or 0.3≤P₂≤0.8.

9. The columnar secondary battery according to claim 1, wherein, along the width direction of the negative electrode plate, the negative current collector comprises a blank foil region connected to the first negative electrode material layer, the blank foil region is provided with a plurality of third stripes, the plurality of third stripes extend along the width direction of the negative electrode plate and are spaced apart along the length direction of the negative electrode plate.

10. The columnar secondary battery according to claim 9, wherein, along the width direction of the negative electrode plate, a ratio of a length of a single third stripe to a width of the blank foil region is P₃, 0.1≤P₃≤0.7.

11. The columnar secondary battery according to claim 10, wherein 0.2≤P₃≤0.5.

12. The columnar secondary battery according to claim 9, wherein, along the thickness direction of the negative electrode plate, a thickness of the negative current collector is T₀ μm, an average depth of a plurality of third stripes in a part of the blank foil region opposite to the first section is T₁ μm, and an average depth of a plurality of third stripes in a part of the blank foil region opposite to the second section is T₂ μm, 3≤T₀≤20, 0.15≤T₂/T₀≤0.7, and 0.45≤ T₁/T₂≤0.95.

13. An electronic device, comprising a columnar secondary battery, the columnar secondary battery comprising an electrode assembly, wherein the electrode assembly comprises a positive electrode plate, a negative electrode plate, and a separator; the negative electrode plate comprises a negative current collector, and a surface of the negative current collector facing away from a winding center of the electrode assembly is coated with a first negative electrode material layer;
along a winding direction of the electrode assembly, the first negative electrode material layer comprises a first section and a second section connected sequentially, and based on a length of the first negative electrode material layer, a length of the first section accounts for 9% to 75%, and a length of the second section accounts for 25% to 91%;
a plurality of first stripes are provided on the first section, the plurality of first stripes extend along a width direction of the negative electrode plate and are spaced apart along a length direction of the negative electrode plate; a plurality of second stripes are provided on the second section, the plurality of second stripes extend along the width direction of the negative electrode plate and are spaced apart along the length direction of the negative electrode plate; along a thickness direction of the negative electrode plate, an average depth of the plurality of first stripes in the first section is H₁ μm, an average depth of the plurality of second stripes in the second section is H₂ μm, and a thickness of the first negative electrode material layer is H₀ μm, 50≤H₀≤100, 0.15≤H₂/H₀≤0.7, and 0.45≤H₁/H₂≤0.95.

14. The electronic device according to claim 13, wherein, based on the length of the first negative electrode material layer, the length of the first section accounts for 17% to 60%, and the length of the second section accounts for 40% to 83%;
and/or,
$$0.3 \leq {H}_{2} / {H}_{0} \leq 0.6 , and 0.7 \leq {H}_{1} / {H}_{2} \leq 0.85 .$$

15. The electronic device according to claim 13, wherein, along the length direction of the negative electrode plate, a spacing between two adjacent first stripes is A₁ mm, and a spacing between two adjacent second stripes is A₂ mm, 0.2≤A₁/A₂≤3, and 2≤A₂≤10.

16. The electronic device according to claim 15, wherein 0.5≤A₁/A₂≤1.5.

17. The electronic device according to claim 13, wherein, along the length direction of the negative electrode plate, a width of a single first stripe is W₁ μm, and a width of a single second stripe is W₂ μm, 0.1≤W₁/W₂≤1.5, and 70≤W₂≤120.

18. The electronic device according to claim 17, wherein 0.6≤W₁/W₂≤1.2.

19. The electronic device according to claim 13, wherein, along the width direction of the negative electrode plate, a ratio of a length of a single first stripe to a width of the first negative electrode material layer is P₁, 0.2≤P₁≤1; or, a ratio of a length of a single second stripe to a width of the first negative electrode material layer is P₂, 0.2≤P₂≤1.

20. The electronic device according to claim 13, wherein, along the width direction of the negative electrode plate, the negative current collector comprises a blank foil region connected to the first negative electrode material layer, the blank foil region is provided with a plurality of third stripes, the plurality of third stripes extend along the width direction of the negative electrode plate and are spaced apart along the length direction of the negative electrode plate.
